(19) United States
(12) Patent Application Publication
(10) Pub. No.: US 2013/0093271 A1
(43) Pub. Date: Apr. 18, 2013

(54) ELECTRIC DEVICE DRIVE ASSEMBLY AND COOLING SYSTEM FOR ELECTRIC DEVICE DRIVE

(71) Applicant: GOGORO, INC., New Taipei City (TW)

(72) Inventors: Hok-Sum Horace LUKE, Mercer Island, WA (US); Matthew Whiting TAYLOR, North Bend, WA (US); Ko Chun JUNG, Taipei City (TW)

(73) Assignee: GOGORO, INC., New Taipei City (TW)

(21) Appl. No.: 13/650,395

(22) Filed: Oct. 12, 2012

Related U.S. Application Data
(60) Provisional application No. 61/546,411, filed on Oct. 12, 2011.
(60) Provisional application No. 61/583,456, filed on Jan. 5, 2012.
(60) Provisional application No. 61/583,984, filed on Jan. 6, 2012.
(60) Provisional application No. 61/615,123, filed on Mar. 23, 2012.
(60) Provisional application No. 61/615,144, filed on Mar. 23, 2012.
(60) Provisional application No. 61/615,143, filed on Mar. 23, 2012.

(51) Int. Cl. H02K 7/10; H02K 9/00; H02K 21/22

(52) U.S. Cl. 310/58; 310/75 R

(57) ABSTRACT

Drive assemblies for electric devices, such as vehicles, include an electric motor that includes a rotor assembly and a stator assembly positioned within the rotor assembly. The stator assembly is fixed to a stationary axle and includes a pole and a coil around the pole. The rotor assembly includes a housing to which a plurality of magnets are attached. The rotor assembly is supported on the stationary axle by bearings. A drive mechanism, such as a sprocket, pulley or gear is provided on the housing of the rotor assembly and rotates with the housing. In various embodiments, the stationary axle includes an internal bore for receiving coolant, a longitudinal rib within the internal bore, and longitudinal channels in its outer surface.

### BACKGROUND

1. Technical Field

The subject matter described herein relates to a drive assembly and cooling system for an electric device, such as a vehicle, e.g., an electric motorcycle or scooter, and in certain embodiments to a motor for an electrically driven device.

2. Description of the Related Art

The concern over the volume and cost of fossil fuels available in the future are fueling the proliferation of electric powered devices such as vehicles, including automobiles, trucks, motorcycles, scooters, golf carts, utility carts, lawnmowers, chain saws, and the like. The motors that drive such vehicles and other electrically powered devices often include designs that have an exposed drive shaft that is connected to an inner rotating rotor or an outer rotating rotor. Such exposed drive shafts spin at high rates and present a potential safety risk to anyone coming in close proximity to the spinning shaft.

Electric motors that include an outer rotating rotor that is connected to a centrally located drive shaft are sometimes referred to as outrunner motors and are a type of brushless motor. Outrunner motors spin more slowly than their inrunner counterparts where the outer shell is stationary, while producing more torque. Outrunner motors have been used in personal electric transportation applications such as electric bikes and scooters partly due to their size and power-to-weight ratios. Because an outrunner motor is a type of brushless motor, a direct current, switched on and off at high frequency for voltage modulation, is typically passed through three or more nonadjacent windings of the stator, and the group of windings so energized is alternated electronically. A cross-section of a typical electric outrunner motor is illustrated in FIG. 10. Motor 900 of a typical outrunner design includes an outer rotor shell 901 that spins around an inner stator 903 carrying coils 905 wrapped around poles 907. The poles and coils of the inner stator is provided on a sleeve or collar 909 coupled by bearings 912 to a rotatable drive shaft 911 that is located on the axial centerline of the motor. Collar 909 in cooperation with bearings 912 isolates static poles 907 and coils 905 from the rotating drive shaft 911. The outer rotor shell 901 carries permanent magnets 913 on its inner surface and is connected to the drive shaft. Each of these components of the electric motor contributes to the weight of the motor.

Both inrunner and outrunner electric motors generate heat as a result of mechanical and electrical friction during motor operation. Cooling electric motors so they do not attain temperatures that will damage motor components or only attain such temperatures for limited periods of time will extend the useful lifetime of the motors. In addition, as demand increases for more powerful motors to drive devices faster and with more acceleration and power, the need to cool such motors efficiently without increasing noise, weight, and complexity will increase. Examples of techniques used to cool electric motors include providing large cooling ribs on external surfaces of the motor or providing fans that provide increased airflow to the internal and/or external components of the motor. While these techniques can contribute to the cooling of an electric motor, they have their drawbacks, such as added weight, increased noise, and added complexity.

With the ever-expanding interest in reducing dependence on fossil fuels and improving the environment, electric vehicles and electrically powered devices will continue to increase in popularity. Vehicle and device owners and manufacturers of such items will be interested in drive assemblies that are more reliable, offer increased power-to-weight ratios, and are of a reasonable cost.

### BRIEF SUMMARY

As an overview, drive assemblies, rotor assemblies, electric devices and electrically powered vehicles including the same, along with methods of cooling stator assemblies, drive assemblies and electric devices are described in the present disclosure. The described drive assemblies and electric devices power devices, such as vehicles or other electrically powered devices utilizing a static axle or shaft. In some embodiments, the drive assemblies and electric devices are internally cooled. Utilizing a static axle means the risk of injury caused by user contact with an axle rotating at a high speed is avoided. Non-limiting examples of electric vehicles powered by electric devices described in this application include motorcycles, scooters, golf carts, automobiles, utility carts, riding lawnmowers and off road recreational vehicles, such as “four-wheelers”. Non-limiting examples of electrically powered devices of the type described in this application include those that can be powered by an electric motor, such as a push lawnmower, riding lawnmower, chainsaw, and the like. Drive assemblies, exemplary embodiments of which are described herein, have structures that are compact, rigid and lend themselves to inclusion of sensors used to monitor operation of the drive assembly and provide operation information to a control system for controlling operation of the drive assembly. In addition, embodiments of drive assemblies described herein, may be internally cooled.

An embodiment of a drive assembly of the type described herein includes a static axle, a stator assembly, and a rotor assembly. The static axle including an internal bore extending along a longitudinal axis of the axle. In some embodiments, a cooling fluid can be flowed through the internal bore to aid in reducing the temperature of the drive assembly. A stator assembly is fixed to the static axle and includes a pole and a coil around the pole. The rotor assembly includes a housing and a plurality of magnets coupled to the housing. The stator assembly is positioned within the rotor assembly and a drive mechanism is provided on the housing.

An electric device in accordance with embodiments described herein includes a drive assembly that includes a static axle having an internal bore extending along a longitudinal axis of the axle. A stator assembly is fixed to the static axle and the stator assembly includes a pole and a coil around the pole. The rotor assembly includes a housing and a plurality of magnets coupled to the housing. The stator assembly is positioned within the rotor assembly and the housing is coupled to a drive mechanism.

In another embodiment of a drive assembly in accordance with embodiments for an electric device of the type described herein, the drive assembly includes a static axle including an internal longitudinal bore. The static axle includes an inner surface defining the bore and an outer surface opposite the inner surface, the inner surface further including at least one longitudinal rib extending substantially parallel to a longitudinal axis of the static axle.

In yet another embodiment of a drive assembly for an electric device in accordance with embodiments described herein, the drive assembly includes a static axle including an internal longitudinal bore. The static axle includes an inner surface defining the bore and an outer surface opposite the inner surface. The outer surface includes at least one longitudinal channel extending substantially parallel to a longitudinal axis of the static axle.

In another embodiment of a drive assembly for an electric device in accordance with embodiments described in this application, the drive assembly includes a static axle including an internal bore containing a first flow path for a coolant fluid and a second flow path for the coolant fluid. The drive assembly further includes a stator assembly fixed to the static axle and including a pole and a coil around the pole. The rotor assembly includes a housing and a plurality of magnets coupled to the housing and the stator assembly is positioned within the rotor assembly. In accordance with this embodiment, a drive mechanism is provided on the housing.

In accordance with other aspects, the present disclosure describes embodiments of cooling a drive mechanism for an electric device. The described embodiments include the steps of passing a coolant through a coolant conduit contained within an electric motor of the drive assembly. In certain embodiments, the coolant conduit passes through an axle of the drive assembly. The coolant exits the coolant conduit into a coolant distribution chamber within the electric motor. The coolant is then contacted with poles and coils of a stator assembly and magnets of a rotor assembly.

In other aspects, the present disclosure describes electrically powered devices that include a drive assembly in accordance with the embodiments described herein.

The present application also describes embodiments of methods for cooling a stator assembly fixed to a static axle that includes a first end and a second end opposite the first end. An embodiment of such methods includes near the first end, receiving coolant fluid into an internal bore within the static axle and flowing the coolant fluid toward the second end of the static axle. Near the second end, the direction coolant fluid flow is changed. In accordance with this embodiment, thermal energy from the drive assembly is transferred to the coolant fluid as it flows through the static axle and the warmed coolant fluid is removed from the internal bore near the first end.

In accordance with other aspects, the present disclosure describes embodiments of cooling a drive mechanism for an electric device. In such embodiments, coolant is carried in an internal bore in a static axle where the coolant fluid absorbs thermal energy from components of the drive assembly that are at temperatures greater than the temperature of the coolant. In these embodiments, The coolant then exits the cooling conduit and flows across components of the drive assembly, such as a stator central body, poles, coils, stator teeth, and magnets. When components such as these are at temperatures greater than the temperature of the coolant, the coolant absorbs thermal energy from such components.

### BRIEF DESCRIPTION OF THE SEVERAL VIEWS OF THE DRAWINGS

In the drawings, identical reference numbers identify similar elements. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and they have been solely selected for ease of recognition in the drawings.

FIG. 1 is a perspective view of a drive assembly according to one embodiment of the present disclosure, attached to a portion of a device to be powered by the drive assembly;

FIG. 2 is a cross-section view along line 2-2 in FIG. 1;

FIG. 3 is an exploded view of the drive assembly of FIG. 1 with the drive wheel removed from the motor and the drive assembly removed from the device;

FIG. 4 is a perspective view of another embodiment of a drive assembly in accordance with the subject matter disclosed herein;

FIG. 5A is a perspective view of another embodiment of a drive assembly in accordance with the subject matter disclosed herein;

FIG. 5B is a perspective view of a modified version of the drive assembly shown in FIG. 5A having a hollow shaft, channels for wires, and wires;

FIG. 5C is a perspective view of a modified embodiment of the drive assembly shown in FIG. 5A with a sensor provided adjacent the drive assembly;

FIG. 6A is an exploded view of the drive assembly of FIG. 5A;

FIG. 6B is an exploded view of the drive assembly of FIG. 5B;

FIG. 6C is an exploded view of the drive assembly of FIG. 5C;

FIG. 7A is a perspective view of the drive assembly of FIG. 5A with one end bell and the flux ring removed;

FIG. 7B is a perspective view of the drive assembly shown in FIG. 5B with one end bell and the flux ring removed;

FIG. 7C is a perspective view of the drive assembly of FIG. 5C with one end bell and the flux ring removed;

FIG. 8 is an end view of a stator in accordance with embodiments described herein;

FIG. 9 is a perspective view of the axle shown in FIG. 5B;

FIG. 10 is a cross-section view of an existing outrunner electric motor design;

FIG. 11 is a block diagram of a system comprising an electric device in accordance with aspects of the subject matter disclosed herein;

FIG. 12 is a cross-section view of an axle containing coolant flow channels in accordance with embodiments described herein;

FIG. 13 is an exploded perspective view of a drive assembly according to one embodiment of the present disclosure, attached to a portion of a device to be powered by the drive assembly;

FIG. 14 is a cross-section view along line 14-14 in FIG. 13;

FIG. 15 is a cross-section view of another embodiment of the present disclosure with a drive mechanism located on a rotor housing;

FIG. 16 is an end view of an axle in accordance with embodiments of the present disclosure;

FIG. 17 is an end view of another axle according to another embodiment of the present disclosure;

FIG. 18 is an exploded perspective view of a drive assembly according to another embodiment of the present disclosure wherein the axle rotates with the rotor, attached to a portion of a device to be powered by the drive assembly; and

FIG. 19 is a cross-section view along line 19-19 in FIG. 18.

### DETAILED DESCRIPTION

It will be appreciated that, although specific embodiments of the subject matter of this application have been described herein for purposes of illustration, various modifications may be made without departing from the spirit and scope of the disclosed subject matter. Accordingly, the subject matter of this application is not limited except as by the appended claims.

In the following description, certain specific details are set forth in order to provide a thorough understanding of various aspects of the disclosed subject matter. However, the disclosed subject matter may be practiced without these specific details. In some instances, well-known structures and methods of attaching structures to each other comprising embodiments of the subject matter disclosed herein have not been described in detail to avoid obscuring the descriptions of other aspects of the present disclosure.

Unless the context requires otherwise, throughout the specification and claims that follow, the word “comprise” and variations thereof, such as “comprises” and “comprising” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present disclosure.

Reference throughout the specification to drive wheel and drive mechanism includes sprockets, pulleys, gears and the like. The phrases drive wheel and drive mechanism should not be construed narrowly to limit it to the illustrated sprocket, gears or described pulleys, but rather, the phrases drive wheel and drive mechanism are broadly used to cover all types of structures that can transfer the rotational movement of a rotor housing to a device to be driven by the drive assembly.

Reference throughout the specification to electric devices includes electric motors, electric generators, and the like. The phrase “electric device” should not be construed narrowly to limit it to the illustrated electric motor, but rather, the phrase “electric device” is broadly used to cover all types of structures that can generate electrical energy from a mechanical input or generate mechanical energy from an electrical input.

The reference to coolant throughout the specification is not limited to air and includes other gases and liquids capable of absorbing thermal energy and transporting thermal energy. Coolants used are preferably selected so as not to have a detrimental effect, e.g., a corrosive effect on components the coolant contacts.

Specific embodiments are described herein with reference to an electric vehicle; however, the present disclosure and the reference to electrically powered devices should not be limited to electric vehicles or any of the other electric devices described herein.

In the figures, identical reference numbers identify similar features or elements and relative positions and size of the features in the figures are not necessarily drawn to scale.

Generally described, the present disclosure is directed to examples of drive assemblies for use in electric devices that include a stator assembly located within a housing of a rotor assembly. The configuration of drive assemblies, examples of which are described by the present disclosure, further include a static axle to which the stator assembly is fixed and a drive mechanism on the rotor assembly housing. Such drive assemblies result in a safer, lighter weight, and more rigid drive assembly. In some embodiments, the static axle includes channels in its outer surface capable of serving as conduits for components such as electrically conducting members. In some embodiments, the static axle is provided with an internal bore for receiving a coolant to remove thermal energy that has been transferred to the axle from other components of the drive assembly, resulting in a cooled drive assembly. In embodiments including a static axle with an internal bore, the internal bore may be s provided with at least one rib extending along its length. In yet other embodiments, the housing is provided with an opening extending from on outer surface of the housing to an inner surface of the housing and at least a portion of magnets of the rotor assembly are exposed through the opening.

Electric motors convert electrical energy into mechanical energy. When electric motors are operated in reverse converting mechanical energy into electrical energy, they are known as generators. Both electric motors and generators operate on the principle involving interaction of magnetic fields and current carrying conductors to generate force or electrical energy. By their nature, electric motors and generators generate heat during operation as a result of mechanical friction and electrical friction occurring in conductive components that carry electric current. The drive assemblies for an electrically powered device described herein include an electric motor or generator including an axle having an internal cooling conduit for receiving a coolant and delivering and distributing the coolant to the interior of the electric device where the coolant removes thermal energy from the electric device and thereby cools it.

In an electric motor, the moving part is called the rotor and the stationary part is called the stator. Magnetic fields are produced on poles which carry lengths of conductive wires called coils wrapped around them. Magnets are provided to interact with the magnetic fields on the poles to produce force. The poles and the magnets can be provided on either the rotor or the stator respectively. Commuter switches or other control mechanisms are typically provided to control current flow to the coils on the poles. In operation, magnetic fields are formed in both the rotor and the stator, and the product between these two fields gives rise to force and thus a torque on the drive mechanism of the motor. One or both of these fields must change with rotation of the motor. This change in field(s) can be achieved by switching the poles on and off in a controlled manner or by varying the strength of the pole.

Examples of electric motors are DC or direct current motors, and AC or alternating current motors. A DC motor is powered by direct current, although there may be an internal mechanism such as a commutator converting direct current to alternating current for part of the motor. An AC motor is supplied with alternating current, often avoiding the need for a commutator. A synchronous motor is an AC motor that runs at a speed fixed to a fraction of the power supply frequency, and an asynchronous motor is an AC motor, usually an induction motor, whose speed slows with increasing torque to slightly less than synchronous speed. The embodiments of an axle including a cooling conduit described herein are applicable to all of these different types of electric motors and electric generators and are not limited in application to specific types of electric motors and generators illustrated and described herein.

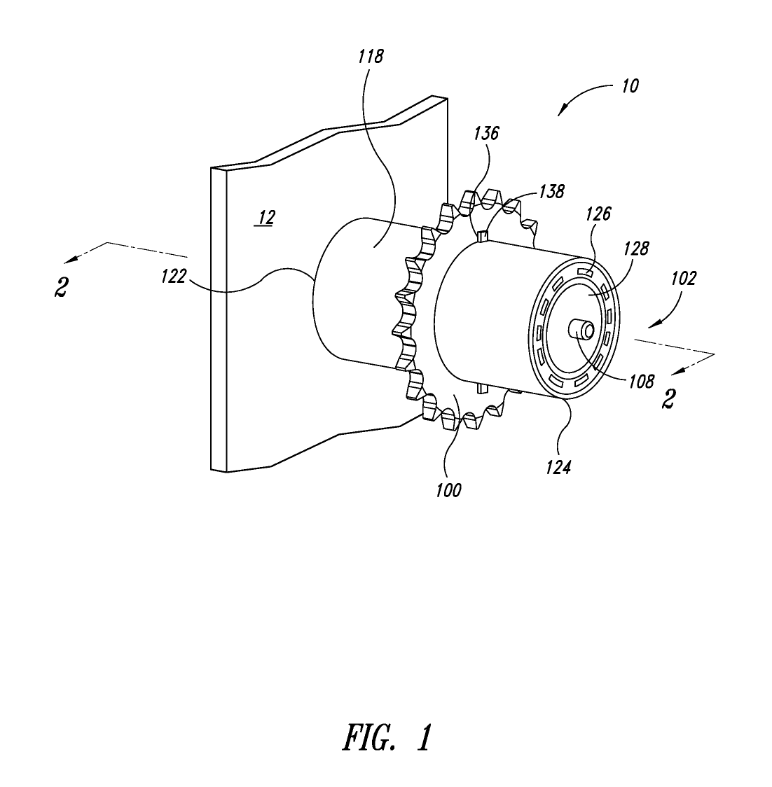

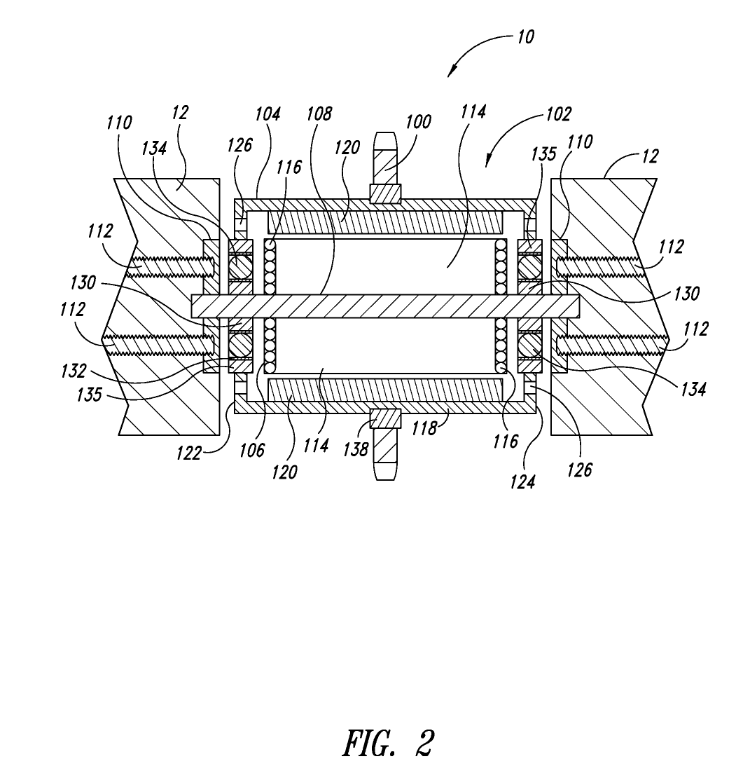

Referring to FIG. 1, a drive assembly 10 is illustrated mounted to a portion of a device frame 12, such as a portion of a motorcycle or scooter chassis. Although not shown in FIG. 1, another portion of the device frame 12 is located on the side of drive assembly 10 opposite the portion of drive frame 12 shown in solid lines in FIG. 1. This other portion of device frame 12 is not shown in FIG. 1 so as to avoid obscuring portions of drive assembly 10. This other portion of device frame 12 is shown in FIG. 2 to the right of drive assembly 10. Drive assembly 10 includes a drive mechanism 100, represented as a drive wheel in the form of a sprocket in FIG. 1. While drive mechanism 100 in FIG. 1 is shown as a sprocket, it is understood that drive mechanism 100 need not be a sprocket, but rather can be a different device for transferring rotational motion of drive mechanism 100 to linear motion of a structure, such as a chain or belt, cooperating with drive mechanism 100. For example, drive mechanism 100 can be a pulley capable of cooperating with a belt or a gear capable of operating with a chain or a belt.

Referring additionally to FIG. 2, drive assembly 10 includes a rotor assembly 104 and a stator assembly 106.

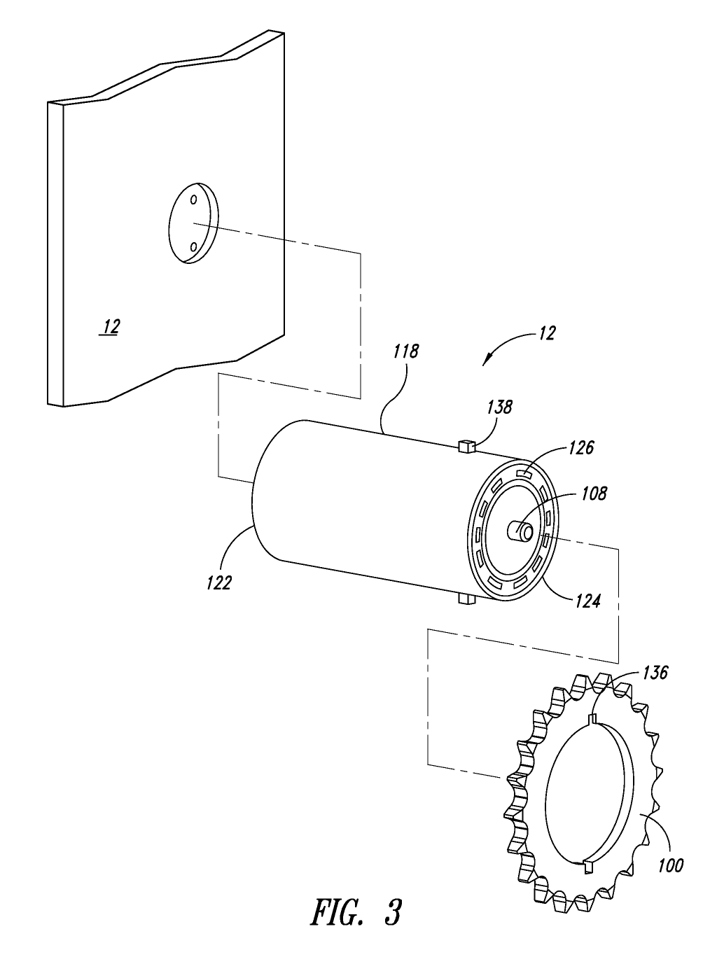

As shown in FIG. 2, drive assembly 10 also includes an axle 108. Axle 108 is located on the centerline of drive assembly 10 and extends from the right end of drive assembly 10 to the left end of drive assembly 10. Each end of axle 108 is fixed to a coupler 110 that is received into a recess in respective device frame portions 12 (shown in FIG. 3) and fixed to the respective device frame portions. When axle 108 is fixed to a coupler 110, it is not able to move relative to the coupler. In the illustrated embodiment, each coupler includes two threaded bores receiving threaded ends of bolts 112 which pass through frame portion 12 and fasten couplers 110 to left and right device frame portions 12. When couplers 110 are fastened to respective device portions 12, they are not able to move relative to device portions 12. In this manner, axle 108 is fixed to device frame portions 12 and is unable to move relative to device frame portions 12. While each coupler 110 is described above as including two threaded bores for receiving threaded bolts, it should be understood that more than two thread bores and more than two bolts per coupler could be used to secure a coupler to a device portion. In addition, other techniques for attaching couplers 110 to a device portion 12 can be used, for example, welding, rivets, compression fittings, set screws and the like.

Stator assembly 106 of the embodiment of FIGS. 1 and 2 includes at least one pole 114 wrapped with a coil 116. Pole 114 and coil 116 can be of a conventional design and made from materials known to be useful in stators of electric devices. Preferably, stator assembly 106 includes a plurality of poles 114, each of which carries its own coil 116. Though not illustrated, the end of pole 114 opposite axle 108 can include a stator tooth of a conventional design. Pole 114 is fixed to axle 108 and therefore is unable to move relative to axle 108. Because coil 116 is wrapped around stationary pole 114, coil 116 is indirectly fixed to axle 108 and is unable to move with respect to axle 108. Pole 114 can be fixed to axle 108 by conventional means such as set screws, welding, compression fittings, bolts, and the like.

Rotor assembly 104 includes a housing 118, which in the embodiment illustrated in FIGS. 1 and 2 is in the shape of a hollow cylinder. The inner surface of rotor housing 118 carries a plurality of permanent magnets 120 sized and located so they face adjacent pole 114 and coil 116 of stator assembly 106. Rotor housing 118 includes first end 122 and an opposite second end 124. First end 122 and second end 124 include vents 126 that pass from the inside of housing 118 to the exterior of housing 118. Air or other cooling fluid may pass through vents 126 into rotor housing to cool motor 102. Magnets 120 are of a conventional design and material and are attached to housing 118 using conventional means.

Each end of axle 108 carries a bearing 128. In the illustrated embodiment, bearing 128 is of a known design and includes an inner race 130 fixed to axle 108, a ball retainer 132 which receives ball bearings 134. Ball retainer 132 and ball bearings 124 are located radially outward from inner race 130. An outer race 136 is located radially outward from ball retainer 132 and ball bearings 134. It should be understood that while a rolling element bearing has been disclosed, other types of bearings or their equivalent, such as bushings, jewel bearings, and sleeve bearings may be utilized and that the subject matter disclosed herein is not limited to the use of a rolling element bearing. Providing bearings in both ends of the drive assembly contributes to the rigidity of the drive assembly which can result in less maintenance, reduced repairs, and longer life.

First end 122 and second end 124 of rotor housing 108 are fixed to the outer race 136 of bearing 128 which allows rotor housing 108 to rotate around axle 108 and stator assembly 106 as these elements remain stationary. Though not shown, electrical connections are provided to coils 116 in a conventional manner and the poles and coils of the stator assembly cooperate with the magnets of the rotor assembly in a conventional manner to cause rotation of the rotor assembly about the stator assembly and axle. The drive assembly can be controlled using conventional equipment and techniques.

Drive assembly 10 further includes a drive mechanism 100 in the form of a drive wheel on housing 118 of rotor assembly 104. In the illustrated embodiment, drive mechanism 100 is a sprocket with teeth for engaging the links of a drive chain (not shown). Drive mechanism 100 has a central bore that includes a keyhole 136 sized and located to cooperate and mate with a key 138 secured to the outer surface of housing 118. While key 138 and keyhole 136 are illustrated as a way to secure drive mechanism 100 to rotor housing 118, the embodiments described herein are not limited to such technique and other techniques for fastening drive mechanism 100 to rotor housing 118 can be used, for example, welding, bolting and the like. When stator assembly 106 is electrically activated, rotor assembly 104 and drive wheel 100 rotate around axle 108 and stator assembly 106. Cooperation between drive mechanism 100 and a chain, belt or other drive mechanism allows the rotational movement created by drive assembly 10 to be transferred into translational movement that can be transferred to the wheels of a vehicle or working portion of a different device that is to be driven by the drive assembly. The drive assembly in accordance with embodiments described herein provides this driving force without an exposed moving axle, resulting a safer electric device.

Drive assemblies of the type described herein are able to drive vehicles and other electrically powered devices while avoiding the need for an exposed rotating shaft. Eliminating user exposure to an exposed drive shaft spinning at a high rate reduces the risk of injury to the user as well as the amount of maintenance needed to keep the exposed shaft in good working order and to remove materials that may collect on the exposed shaft.

Another advantage of drive assemblies of the type described herein is an ability to conveniently locate sensors, such as Hall sensors, signals from which can be used to detect the location of the rotor which is delivered to a motor controller so that more precise control of the motor can be achieved.

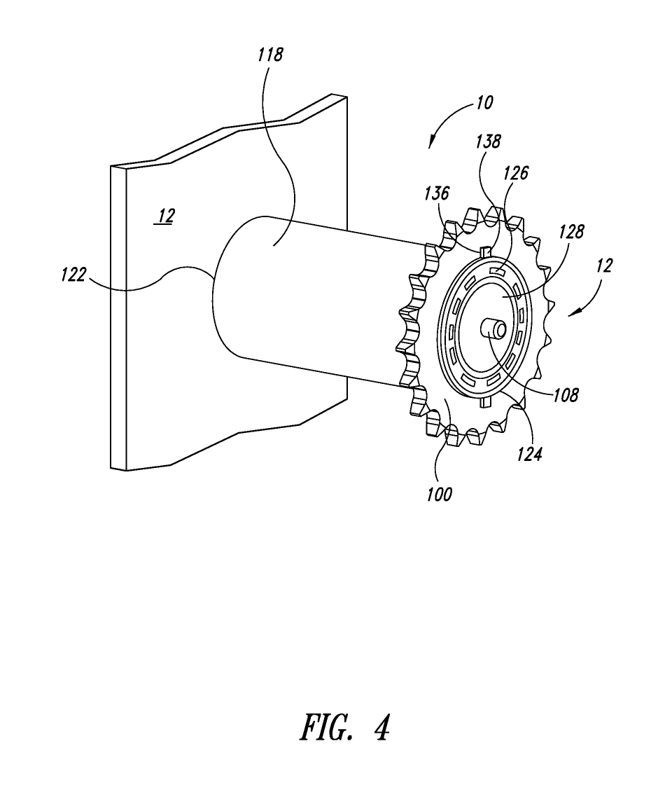

In another embodiment of an example of a drive assembly of the type described herein illustrated in FIG. 4, only first end 122 of drive assembly 10 is secured to device frame portion 12. In this embodiment, drive mechanism 100 is located on rotor housing 118 adjacent the second end 124. In an alternative to the embodiment illustrated in FIG. 4, drive mechanism 100 is positioned adjacent the first end 122.

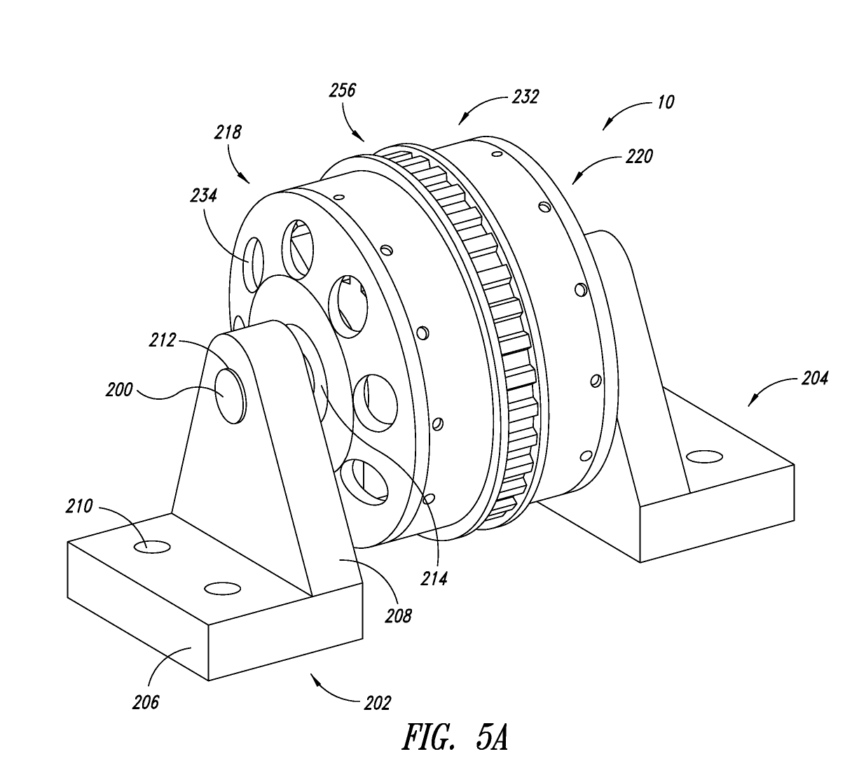

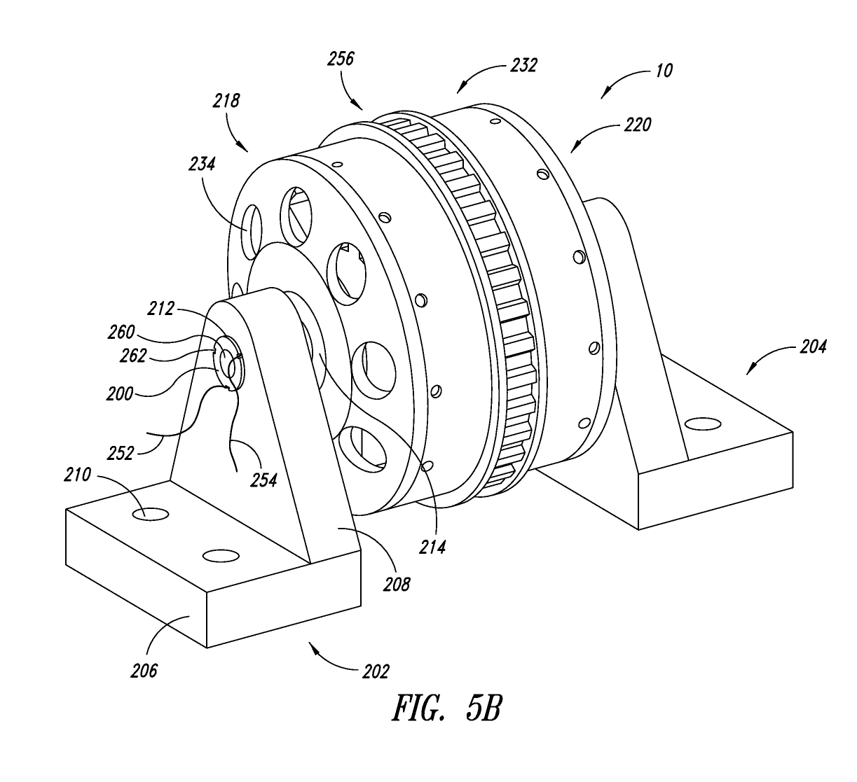

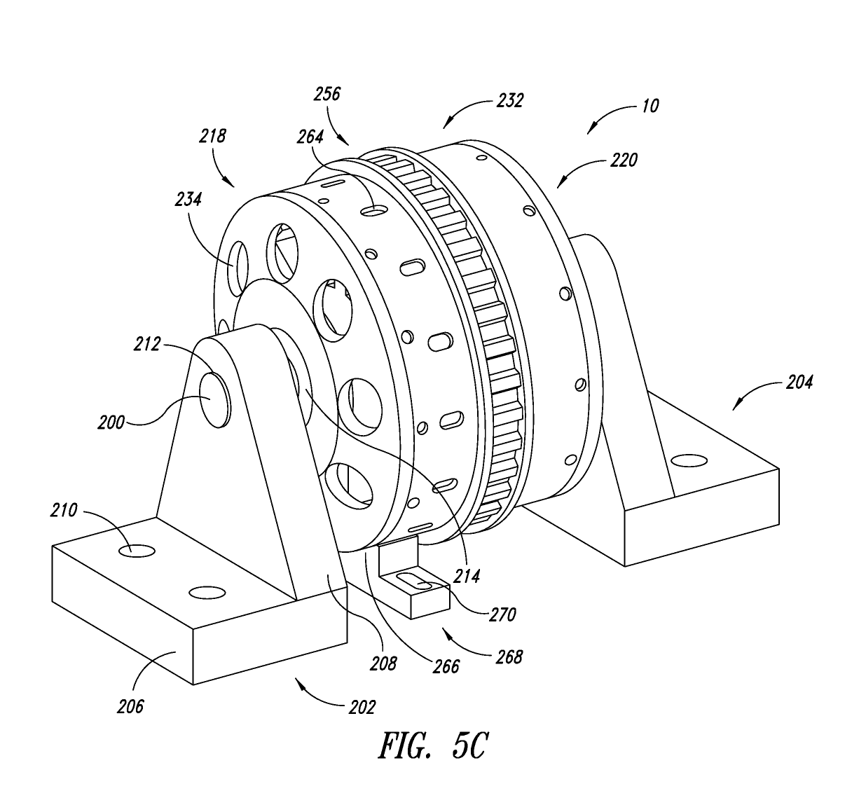

Referring to FIG. 5A, another embodiment of a drive assembly of the type described herein is illustrated. The drive assembly illustrated in FIG. 5A includes a static axle 200 having one end received and supported by first mounting bracket 202 and an opposite end received and supported by a second mounting bracket 204. In the orientation shown in FIG. 5A, first mounting bracket 202 includes a horizontal leg 206 and a vertical leg 208 that extends perpendicular to horizontal leg 206. In the illustrated embodiment, horizontal leg 206 includes two bores 210 for receiving devices such as bolts to secure horizontal leg 206 to a frame of the electric device to be powered by drive assembly 10. An end of vertical leg 208 opposite horizontal leg 206 includes a bore 212 that receives and secures one end of static axle 200. Though not shown, bore 212 can include a key that is received by a key receiver in the outer surface of the axle or the bore can include a key receiver that receives a key that is provided on the outer surface of the axle. Cooperation between the key and key receiver serve to fix the axle to the mounting bracket so the axle is unable to rotate relative to the mounting bracket. Second mounting bracket 204 is a mirror image of first mounting bracket 202 and therefore the description regarding first mounting bracket 202 also applies to second mounting bracket 204.

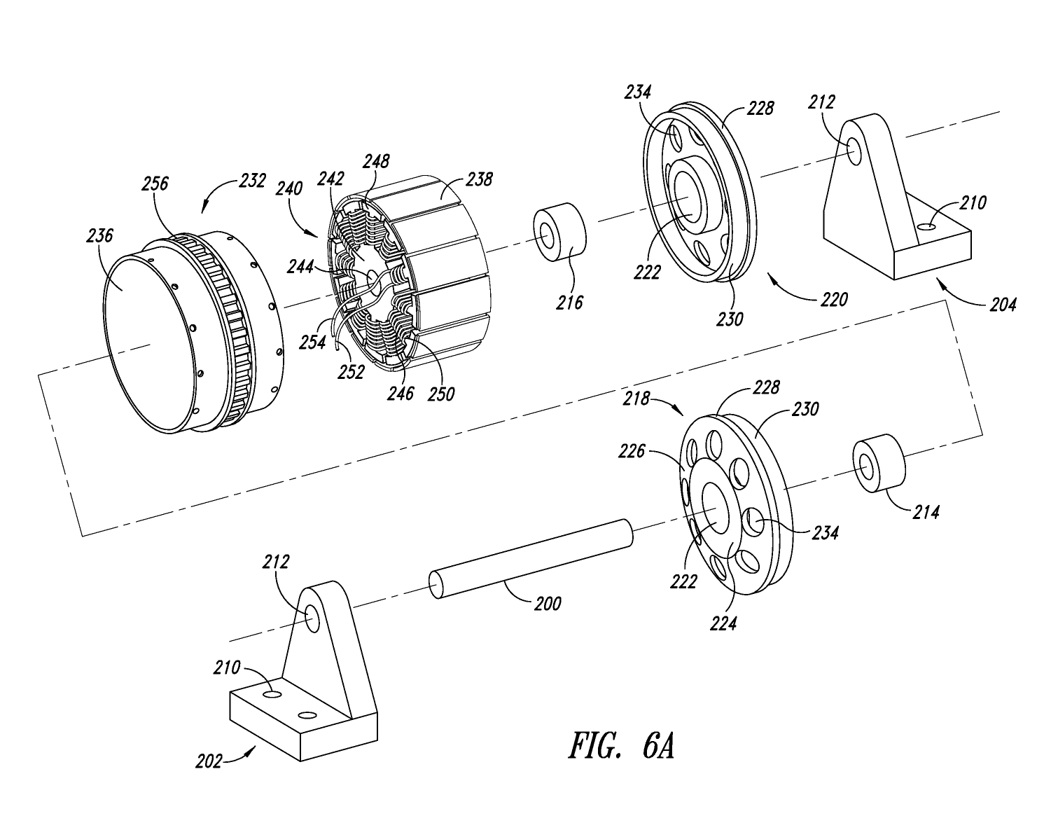

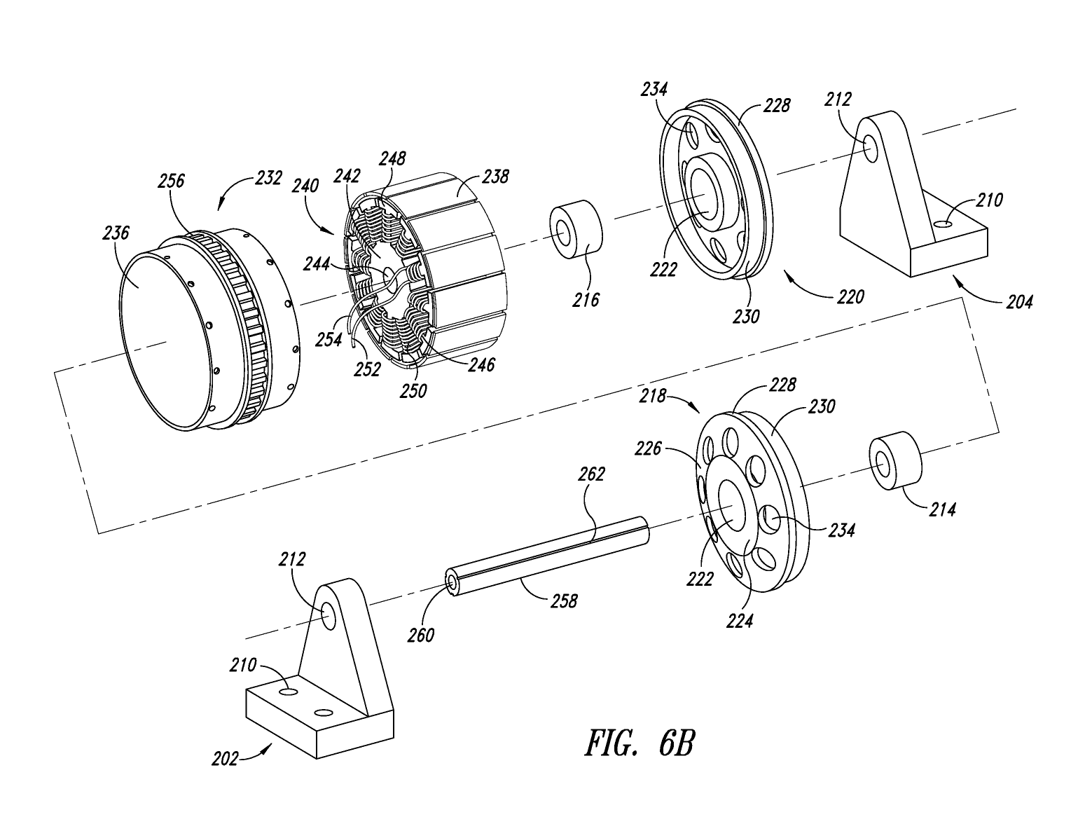

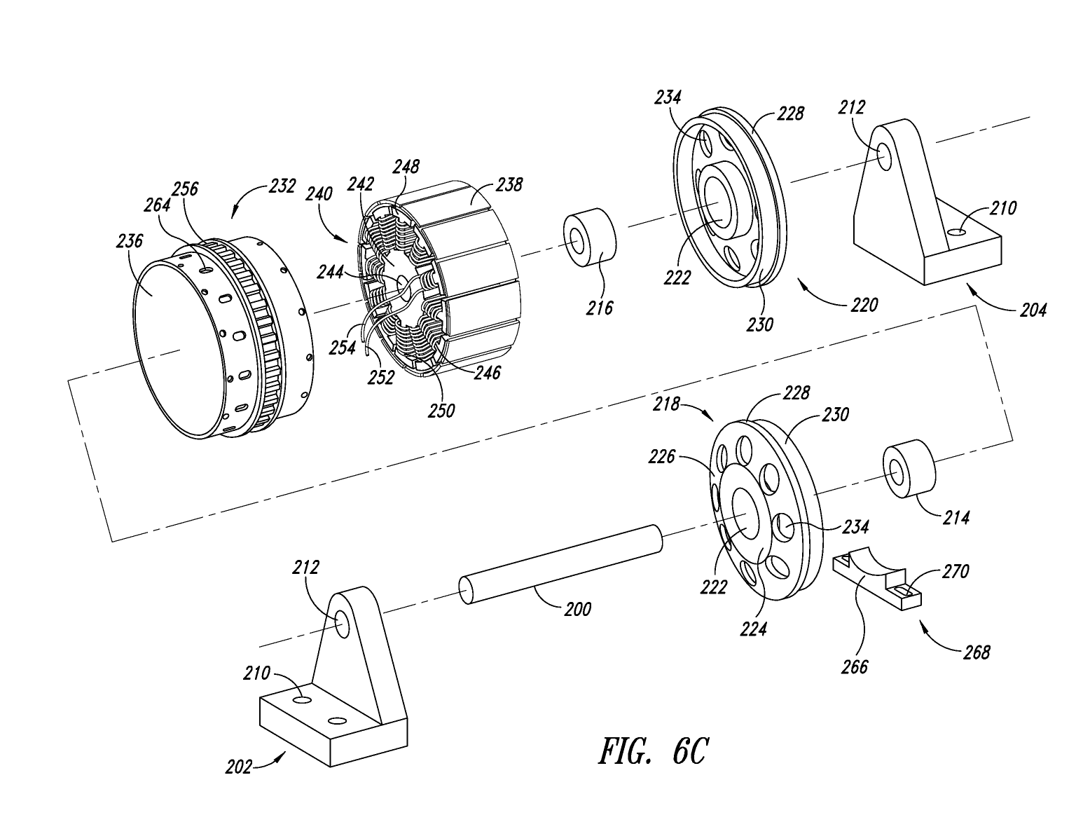

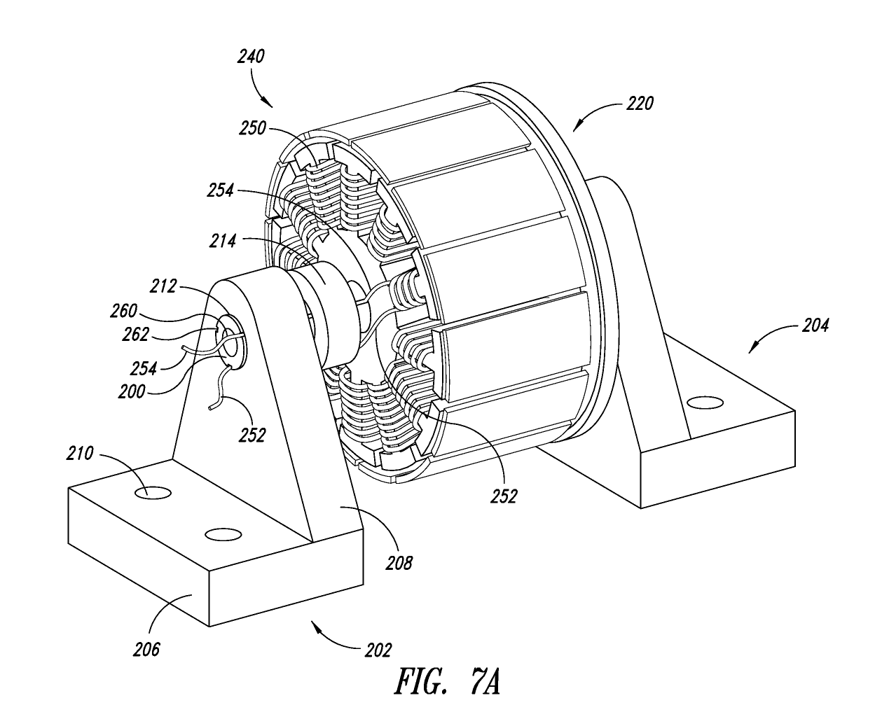

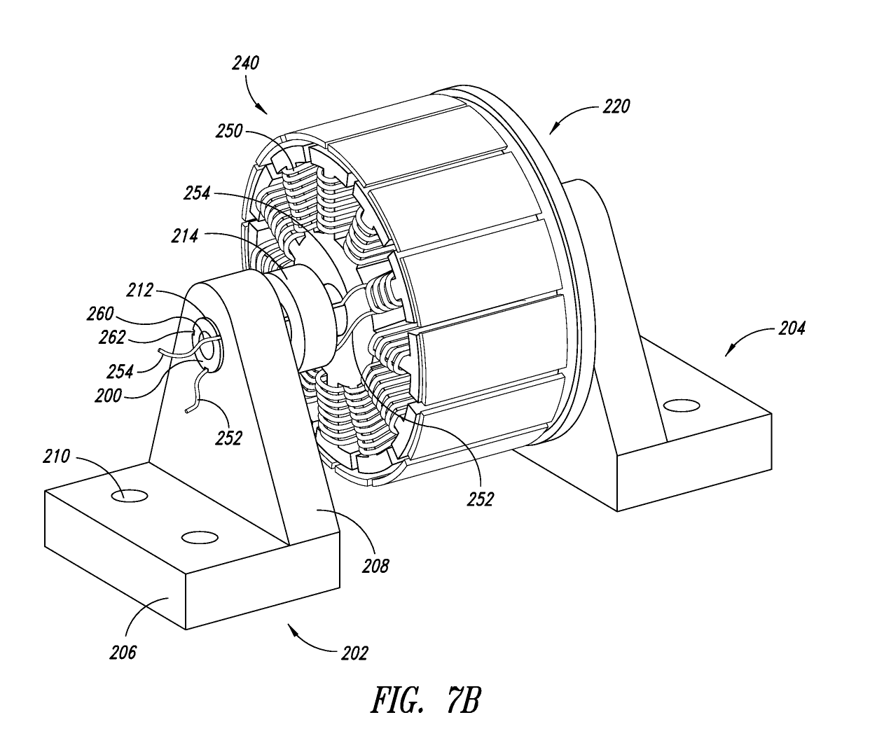

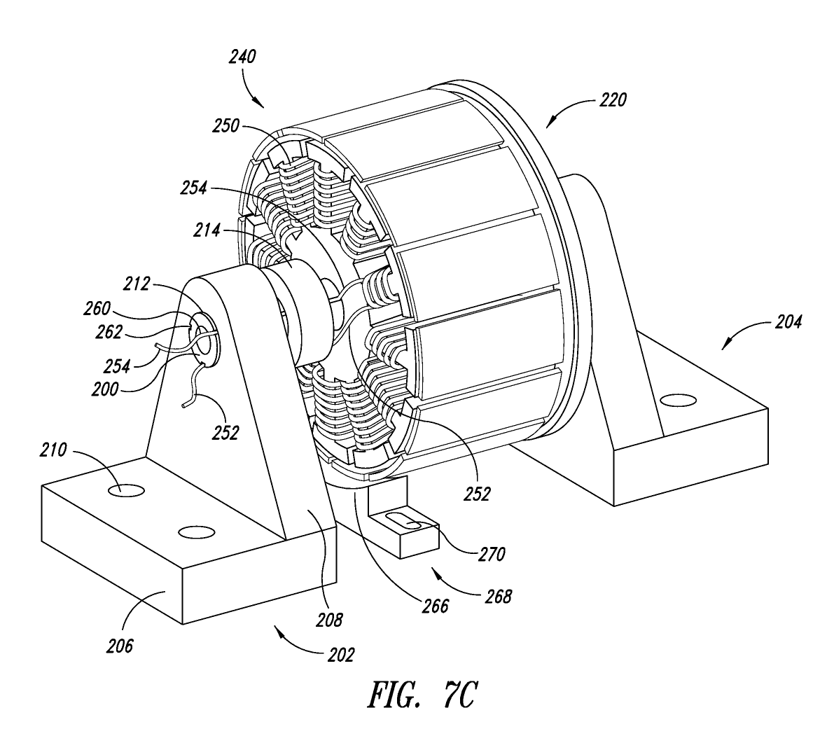

Referring additionally to FIGS. 6A and 7A, static axle 200 carries bearing 214 adjacent first mounting bracket 202 and bearing 216 adjacent second mounting bracket 204. Bearings 214 and 216 can be roller element bearings, but the drive assemblies described herein are not limited to using rolling element bearings. In the illustrated embodiment showing a rolling element bearing, an inner race (not shown) for each bearing is fixed by conventional means to axle 200. In the illustrated embodiment, drive assembly 10 includes first end bell 218 and second end bell 220. Second end bell 220 is a mirror image of first end bell 218. Accordingly, the following description of first end bell 218 also applies to second end bell 220. End bell 218 is a round plate-shaped member including a central bore 222 that receives the outer race of bearing 214. Around central bore 222 is a collar 224. Surrounding collar 224 is a beveled shoulder 226 that extends away from the respective mounting bracket and to an outer peripheral edge 228 of end bell 218. From outer peripheral edge 228, the surface of end bell 218 opposite beveled shoulder 226 steps down in diameter to an annular shelf 230.

The illustrated drive assembly drive assembly 10 further includes a annular-shaped flux ring 232 forming a housing of the rotor assembly. The flux ring 232 has an inner diameter substantially equal to the outer diameter of annular shelf 230 such that annular shelf 230 of first end bell 218 is received in one open end of annular flux ring 232. The opposite open end of annular flux ring 232 receives the annular shelf 230 of second end bell 220. Both beveled shoulders 226 of end bells 218 and 220 include passageways 234 extending from the outer surface of annular shelves 230 to the inner surface of annular shelves 230. Passageways 234 provide access for cooling fluid to flow into, through and out of the chamber formed by end bells 218 and 220 and flux ring 232.

The inner surface 236 of flux ring 232 carries a plurality of rectangular-shaped magnets 238 best seen in FIGS. 6A and 7A positioned adjacent stator assembly 240. Though magnets 238 are shown as being rectangular-shaped, it is understood that the embodiments described herein are not limited to magnets that are of a rectangular shape. Magnets 238 are spaced around the inner circumference of flux ring 232 in an equally spaced manner.

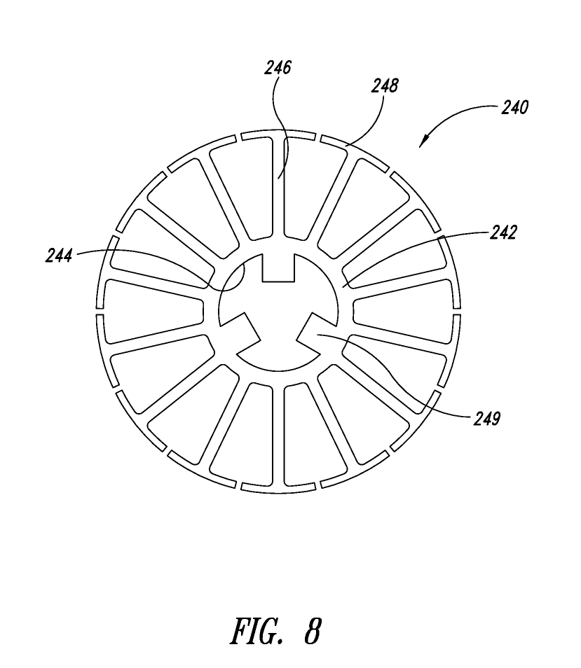

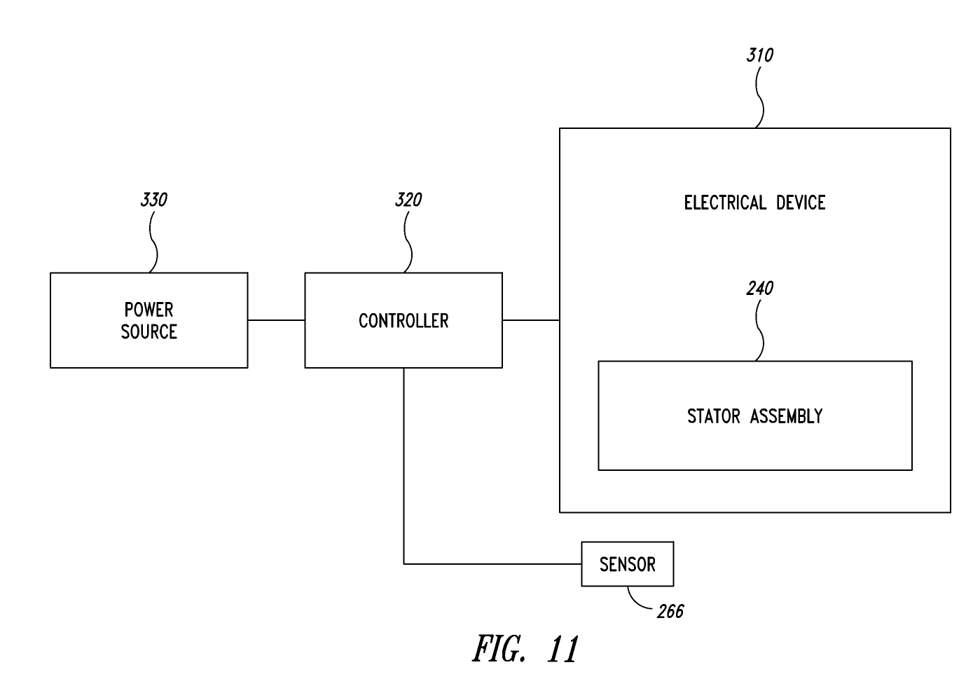

In the illustrated embodiment, drive assembly 10 further includes a stator assembly 240. Referring additionally to FIG. 8, stator assembly 240 includes a stator collar 242 forming a central part of stator assembly 240. Passing through the center of stator collar 242 is stator bore 244. Stator bore 244 has a diameter substantially equal to the outer diameter of static axle 200 such that stator bore 244 may receive axle 200 and stator assembly 240 can be fixed to static axle 200. Radiating outward from stator collar 242 are a plurality of poles 246. In the illustrated embodiment, twelve poles are illustrated; however, it should be understood that a larger number or a smaller number of poles can be utilized. Stator poles 246 terminate in stator teeth 248 which in the illustrated embodiment are rectangular-shaped flat plates attached to the outermost radial ends of poles 246. The outer surface of stator teeth 248 define a circumference that has a diameter slightly less than the diameter defined by the inner surface of magnets 238 affixed to the inner surface of flux ring 232. As illustrated in FIG. 7A, coils 250 of conductive wires are provided around at least one of poles 246. The coils 250 are wound around poles 246. Ends 252 and 254 of the wire forming coil 250 are best seen in FIG. 7A. Each end 252 and 254 of the coil 250 wrapped around pole 246 of the stator assembly 240 may be selectively coupled to terminals of a power source (shown in FIG. 11) using conventional techniques. The power source may be any power source, including a battery. One of the terminals of the power source is configured to supply a current to coil 250. As current flows through coils 250, a first electromagnetic field is generated. As current flows through other coils, additional electromagnetic fields are generated. These electromagnetic fields interact with the magnetic field generated by magnets 238 and cause flux ring 232 to rotate about axle 200.

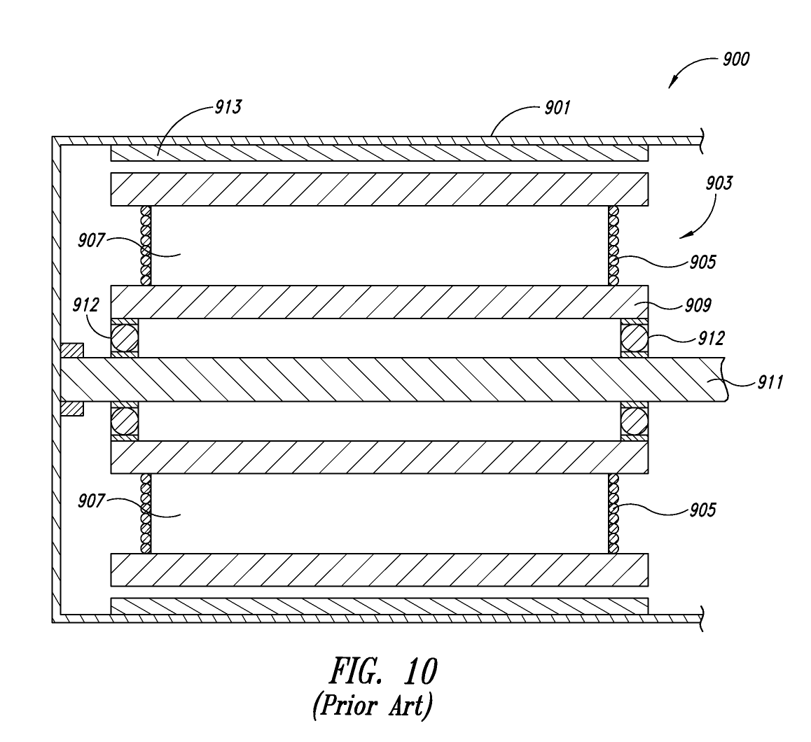

Unlike conventional outrunner electric motors, the drive assemblies of embodiments described herein do not require a shaft collar 909 in FIG. 10. Omission of the shaft collar 909 results in a drive assembly that does not include structure which otherwise would contribute to the weight and overall size of the drive assembly 10. For example, without a shaft collar, the inner diameter of the stator defined by the central bore passing through the stator can be reduced. When the inner diameter of the stator is reduced and the radial length of the poles remains the same, the diameter of the imaginary circle occupied by the magnets carried by the rotor is reduced. As a result of the diameter of the imaginary circle being reduced, the size of the magnets on the inner surface of the rotor can be reduced. The reduced size of the magnets translates into a reduction in the physical size, weight, and cost of the motor, without compromising the power output of the electric motor.

As flux ring 232 rotates around axle 200, drive mechanism 256 can cooperate with a belt, chain, sprocket or the like to transfer the rotational motion of flux ring 232 into linear motion in a chain, belt or the like that can be used to drive a device.

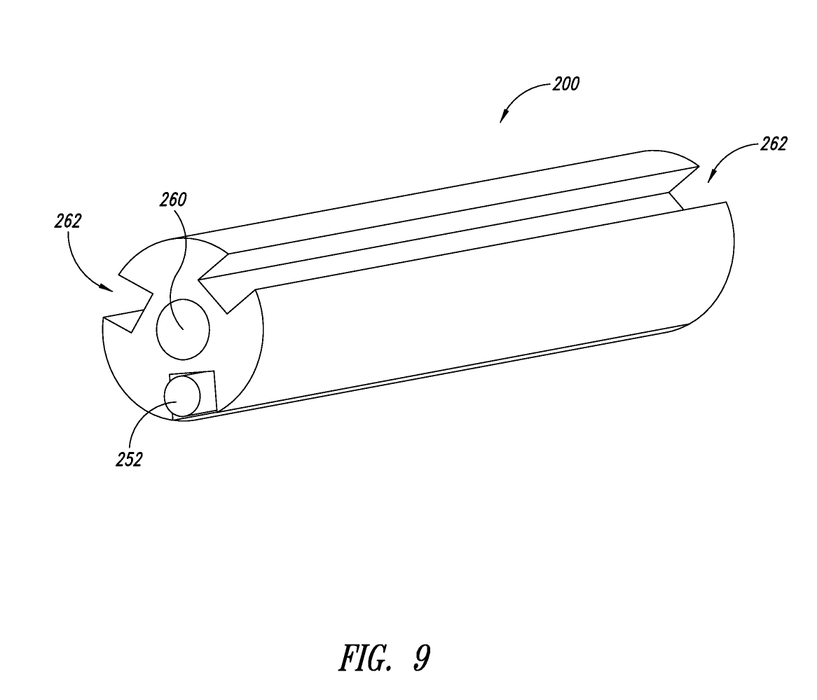

Referring to FIGS. 5B, 6B, and 7B, another embodiment of a drive assembly in accordance with examples described herein is similar to the embodiment described above with regard to FIGS. 5A, 6A, and 7A; however, the axle 258 in the embodiment of FIGS. 5B, 6B, and 7B includes a central bore 260 that extends along the length of axle 258 as best seen in FIG. 9. In addition, axle 258 also includes a plurality of channels 262 formed in the outer periphery of axle 258 that extend along the length of axle 258. It should be understood that while bore 260 in the embodiment illustrated in FIGS. 5B, 6B, and 7B has a round cross section, it should be understood that bore 260 can have other shapes such as a rectangle, triangle, or other polygonal shape. In addition, it should be understood that channels 262 are not limited to the square cross sections that are illustrated in FIGS. 5B, 6B, and 7B. For example, channels 262 can have cross sections that are different shapes, including triangular, rounded, or other polygonal shapes. In addition, bore 260 and channels 262 are shown as extending along the entire length of the axle, but is should be understood that bore 260 and channels 262 need not extend along the entire length of axle 258. In addition to reducing the weight of axle 258, as seen in FIG. 5B, channels 262 also serve as receptacles for conductive wires 252 and 254 that are connected to respective ends of coils 250 and ultimately to power source 330 in FIG. 11. It should be understood that a larger number or a smaller number of channels can be provided in the outer periphery of axle 258.

Providing axle 258 with bore 260 provides several benefits, including reducing the weight of axle 258, which will reduce the overall weight of drive assembly 10. In addition, bore 260 can be utilized to receive cooling fluid that can transfer thermal energy from axle 258, thus cooling axle 258. Cooling axle 258 can also result in cooling of other elements of drive assembly 10 which are in thermal contact with axle 258, such as the stator assembly. Though not shown, the ends of bore 260 that extend out of first mounting bracket 202 and second mounting bracket 204 can be threaded to receive a coupling from a source of cooling fluid and to receive a conduit for delivering the cooling fluid away from the axle. Suitable cooling fluids include liquids and gases.

Referring to FIGS. 5C, 6C, and 7C, another embodiment of a drive assembly in accordance with the examples described herein is shown. Drive assembly 10 shown in FIGS. 5C, 6C, and 7C is similar to the drive assembly 10 shown in FIGS. 5A, 6A, and 7A. The embodiment illustrated in FIGS. 5C, 6C, and 7C includes openings 264 formed through flux ring 232 so as to expose at least a portion of separate magnets carried on the inner surface of the flux ring 232. In the illustrated embodiment, openings 264 are shown as being positioned between drive mechanism 256 and end bell 218. It should be understood that drive assemblies in accordance with embodiments described herein are not limited to those where openings 264 are located in the positions illustrated in FIG. 5C or those having the specific number of openings shown. For example, more or fewer openings 264 can be positioned in different locations on flux ring 232. In addition, openings 264 are illustrated as being oval-shaped and equally spaced around the circumference of flux ring 232. It should be understood that the present embodiments are not limited to oval openings or to openings that are equally spaced around the circumference of the flux ring. For example, openings 264 can be square or triangular or round, and may be unequally spaced around the circumference of flux ring 232.

The embodiments of FIGS. 5C, 6C, and 7C further include a sensor 266 mounted on a sensor base 268 that includes a bolt hole 270 for securing sensor base 268 to a substrate. The sensor 266 is of the type that can detect the magnetic field produced by magnets 238 and that are attached to the inner circumference of flux ring 232 and the combination of poles and coils forming the stator assembly. An example of a sensor for detecting the magnetic field generated by magnets 238 and the poles and coils is a Hall sensor. It should be understood that the present embodiments are not limited to Hall sensors and that other sensors capable of sensing magnetic fields can also be utilized. Sensor 266 as seen in FIG. 11 communicates with controller 320 that is also connected to power source 330 and electric device 310. In accordance with the system illustrated in FIG. 11, system 300 includes a controller 320 such as a microprocessor or digital circuitry, electrically coupled to a power source 330, and to electric device 310. Using known techniques, controller 320 is configured to selectively couple power source to electric device 310. In particular, controller 320 is configured to selectively couple power source 330 to ends of coils 250 (in FIG. 6B) of stator assembly 240 to generate current therein.

In use, controller 330 may control the output of power source 330 to electric device 310 based on the electric device 310 reaching a particular speed, i.e., flux ring 232 reaching a particular number of rotations per minute as detected by the sensor 266 detecting the speed at which the magnets 238 are passing sensor 266. In accordance with the embodiment of FIGS. 5C, 6C, and 7C, openings 264 result in portions of magnets 238 being exposed, thus allowing sensor 266 to sense the presence of the magnets 238 with reduced interference from the flux ring.

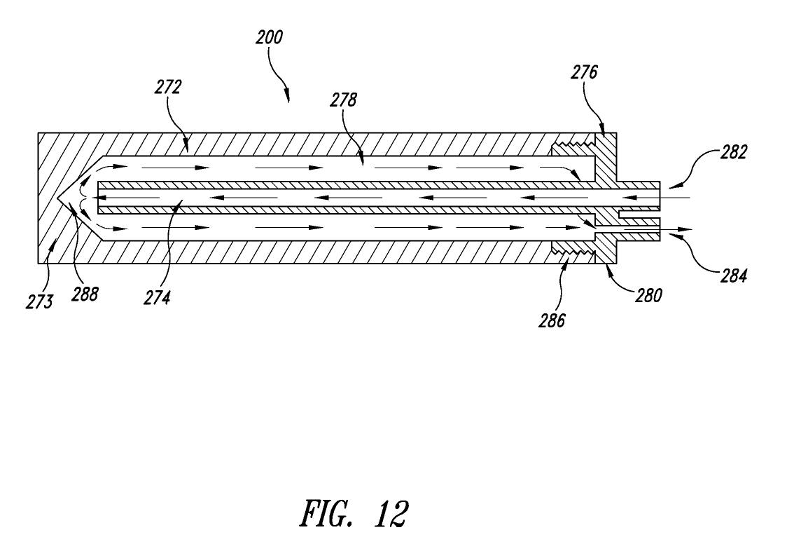

Referring to FIG. 12, in another embodiment of the subject matter described herein, axle 200 includes an internal bore 272 that is closed on one end (the left end in FIG. 12). In accordance with this embodiment, internal bore 272 contains a first flow path defined by a cylindrical conduit 274. The first flow path extends from a first end 276 opposite the closed end of internal bore 272 towards a closed end 273. In the embodiment illustrated in FIG. 12, surrounding first flow path 274 is a second flow path 278 that extends from closed end 273 to first end 276. First end 276 of axle 200 is provided with a manifold 280 that includes a coolant inlet 282 in fluid communication with first flow path 274 and a coolant outlet 284 in fluid communication with second flow path 278. Manifold 280 also includes threaded member 286 cooperating with threads within internal bore to secure the manifold to the static axle 200. End of first flow path 274 opposite coolant inlet 282 terminates adjacent a coolant fluid return surface 288. In the embodiment illustrated in FIG. 12, coolant return surface 288 is a conical surface increasing in diameter as it extends towards the outlet of first flow path 274. Coolant fluid exiting first flow path 274 impinges upon coolant return surface 288 and is directed outward from first flow path 274 into second coolant flow path 278 in a direction opposite to the flow of coolant in first flow path 274.

In use, coolant is introduced into coolant inlet 282 where it flows through first flow path 274 and exits adjacent coolant return surface 288. Coolant return surface 288 helps to guide the coolant fluid into second flow path 278 which is adjacent to the outer surface of internal bore 272. As coolant flows through second flow path 278, thermal energy is transferred to the coolant when the temperature of the axle is higher than the temperature of the cooling fluid. In this manner, cooling fluid is able to reduce the temperature of static axle 200. The coolant fluid is removed from internal bore 272 through coolant outlet 284. Utilization of the axle 200 illustrated in FIG. 12 helps to not only cool axle 200 but also features of drive assembly 10 that are in thermal contact with axle 200 such as the stator and bearings.

Though not illustrated it should be understood that a more than one of flow channel can be provided to deliver coolant fluid from coolant inlet 282 to coolant return surface 288. In addition, more than one flow channel can be provided to deliver coolant from coolant return surface 288 to coolant outlet 284. Further, coolant return surface need not be conical, but be of another shape suitable for directing coolant from first flow path 274 into second flow path 278. Flow of the coolant within internal bore 272 can be further affected by providing baffles or fins within the bore to redirect the coolant.

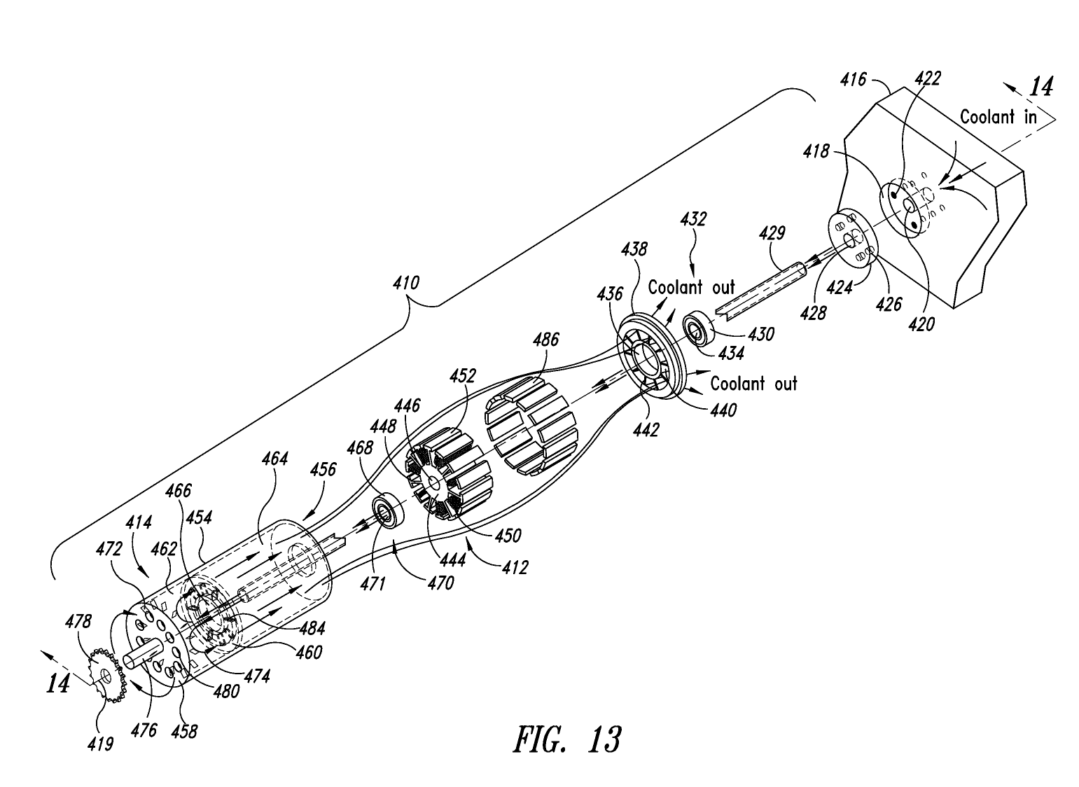

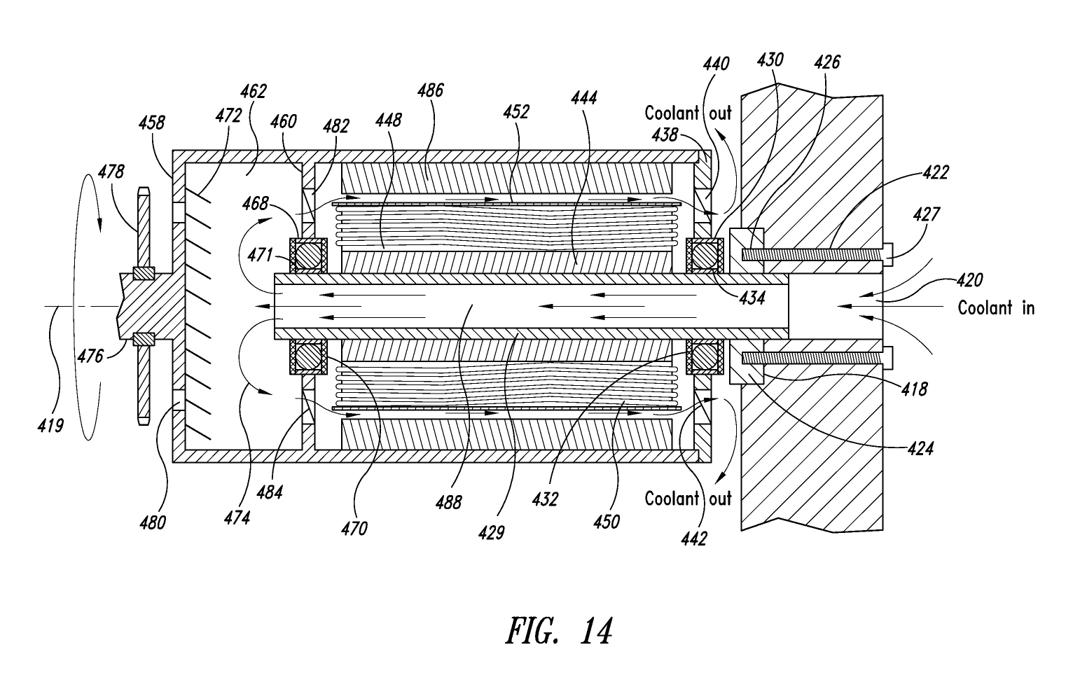

Referring to FIGS. 13 and 14, drive assembly 10 is illustrated in combination with a device frame 416 to which the drive assembly is attached in the embodiment illustrated in FIG. 13. In the following description, device frame 416 will be described in the context of a frame for a vehicle, such as a motorcycle or electric scooter; however, the reference to a device frame is not limited to a frame for a vehicle such as a motorcycle or electric scooter. Device frame 416 includes a round countersunk cavity 418 in a side of device frame 100 to which drive assembly 10 is attached. Countersunk cavity 418 is centered on an axial centerline 419 of drive assembly 10. Located concentrically within round cavity 418 is a round bore 420 extending through device frame 416. In the illustrated embodiment, four smaller bores 422 extend through device frame 416 and are located on a circle positioned concentrically with respect to round bore 420. The circle defined by the smaller bores 422 has a radius greater than the radius of round bore 420 and less than the radius of round cavity 418.

Round cavity 418 receives a stator block 424. Stator block 424 is a round block having an outer diameter substantially equal to the inner diameter of round cavity 418 such that the stator block fits snugly within round cavity 418. Stator block 424 includes threaded cavities 426 that extend into the face of stator block 424 facing device frame 416 and sized to receive threaded ends of bolts (427 in FIG. 2) whereby stator block 424 is secured to device frame 416. In the illustrated embodiment, threaded cavities do not extend completely through stator block 424, but the present disclosure is not so limited and the threaded cavities may extend completely through stator block 424. Stator block 424 also includes a central bore 428 extending through stator block 424 and sized to receive an end of axle 429. In the embodiment shown in FIGS. 13 and 14, bore 428 is sized to receive the end of axle 429 such that axle 429 does not rotate with respect to stator block 424 and/or device frame 416. Though not illustrated, components for coupling axle 429 to stator block 424 and/or device frame 416 such that axle 429 does not rotate relative to stator block 424 include known components such as keys, grooves, and set screws.

Axle 429 carries bearing 432 that includes an outer race 430 and an inner race 434. Axle 429 is fixed to inner race 434 by known means, such as welding, and outer race 430 of bearing 432 is seated within a bore 436 centrally located within round shaped front cover 438 and fixed to front cover 438. Round shaped front cover 438 has an outer diameter sized to mate with an open end 456 of a rotor housing 454 described below. Front cover 438 includes an annular passageway 440 centered on axial centerline 419 that extends through front cover 438 in a direction parallel to the longitudinal axis of axle 436. In the embodiment illustrated in FIGS. 13 and 14, annular passageway 440 includes optional radially extending blades 442. The size, number and shape of blades 442 can vary depending upon a number of factors, such as the necessary structural rigidity of front cover 438 and the pressure or vacuum generated by the blades as front cover 438 rotates. It should be understood that in some embodiments of the present disclosure, annular passageway 440 of the front cover is not provided with blades 442.

Continuing to refer to FIGS. 13 and 14, drive assembly 10 further includes a stator assembly 412. In FIGS. 13 and 14, stator assembly 412 is of a known design and includes a central body 444 including a central bore 446 centered on and extending in a direction parallel to the axial centerline 419. Central bore 446 is sized to receive axle 429. In the embodiment illustrated in FIGS. 13 and 14, central body 444 is fixed to axle 429 by known techniques such as keys, grooves, set screws, welding and the like. Radiating from central body 444 are a plurality of poles 448 around which are wrapped lengths of conductive wire forming coils 450. The ends of poles 448 opposite central body 444 are capped by stator teeth 452.

Drive assembly 10 further includes a rotor assembly 414 that includes a cylindrically shaped rotor housing 454 including an open end 456 closed off by front cover 438, as best seen in FIG. 14. The end of rotor housing 454 opposite open end 456 is closed off by rotor cap 458. Rotor housing 454 further includes an intermediate rotor cap 460 located between open end 456 and rotor cap 458. Intermediate rotor cap 460 divides rotor housing 454 into a coolant distribution chamber 462 adjacent rotor cap 458 and a magnet containing section 464 adjacent open end 456. Intermediate rotor cap 460 is attached to the inner periphery of rotor housing 454 and includes a centrally located inner bore 466 sized to receive and be secured to outer race 468 of bearing 470. Bearing 470 includes an inner race 471 sized to receive and be fixed to axle 429. Cooperation between axle 429, bearing 470, intermediate rotor cap 460, bearing 432, and front cover 438 allows rotor housing 454 to rotate with respect to axle 429.

Continuing to refer to FIGS. 13 and 14, the face of rotor cap 458 facing intermediate rotor cap 460 carries a plurality of blades 472. In the embodiment illustrated in FIGS. 13 and 14, blades 472 are shown as straight members; however, it should be understood that the size, orientation, and shape of blades 472 can be varied to achieve the desired coolant flow within the coolant distribution chamber. For example, blades 472 can be configured to direct coolant as illustrated by arrows 474 in FIGS. 13 and 14. Alternatively, or in addition, blades 472 can be configured to draw coolant through axle 429 into coolant distribution chamber 462 and/or draw coolant into coolant distribution chamber 462 through holes 480 in rotor cap 458. The side of rotor cap 458 opposite the side that carries blades 472 supports a drive shaft 476 centered on the axial centerline of drive assembly 10. Drive shaft 476 carries drive mechanism 478, e.g., a sprocket, pulley or belt drive. Rotor cap 458 further includes a plurality of optional vent holes 480 permitting the ingress or egress of coolant into or out of coolant distribution chamber 462.

Intermediate rotor cap 460 includes an annular passageway 482 having an inner radius greater than the radius of central bore 466 and an outer radius less than the outer radius of intermediate rotor cap 460. Annular passageway 482 includes optional blades 484 that may be located, sized, and shaped to direct the coolant in the desired direction. For example, in the embodiment illustrated in FIGS. 13 and 14, blades 484 serve to direct coolant from the coolant distribution chamber 462 into the magnet containing section 464. As with front cover, it should be understood that while annular passageway 482 in FIGS. 13 and 14 is illustrated with blades, in other embodiments of the present disclosure, annular passageway 482 does not include blades 472.

Magnet containing section 464 of rotor housing 454 includes a plurality of magnets 486 coupled to the inner surface of rotor housing 454 and spaced circumferentially from each other. Rotor magnets 486 include conventional permanent magnets known for use in electric motors and generators. When stator assembly 412 is positioned within rotor assembly 414, rotor magnets 486 are spaced radially from stator teeth 452. Coolant that enters magnet containing section 464 from coolant distribution chamber 462 passes across and over magnets 486, stator teeth 452, coils 450, and poles 448 in a direction toward front cover 438. When the coolant reaches front cover 438, it passes through annular passageway 440 in front cover 438 and out of drive assembly 10. When the coolant is an inexpensive environmentally friendly gas or liquid, such as air or water, it is not necessary to collect the exhausted coolant for recycle or disposal. On the other hand, if the coolant is a gas or liquid that is not environmentally friendly or is costly enough to warrant recycling, it may be collected, cooled and disposed of or recycled back through axle 429.

As best seen in FIG. 14, axle 429 extends from a location within device frame 416 through stator block 424, bearing 432, front cover 438, stator assembly 412, bearing 470, and intermediate rotor cap 460. Axle 436 includes a conduit 488 (in FIG. 14) that serves as a passageway for receiving and delivering coolant from the end of axle 429 located within device frame 416 to the coolant distribution chamber 462. Coolant received in coolant distribution chamber 462 is redirected through annular passageway 482 in intermediate rotor cap 460, through magnet containing section 464, and out through annular passageway 440 in front cover 438. Coolant that enters coolant conduit 488 is generally at a temperature that is lower than the temperature of the various components of drive assembly 10 and thus absorbs thermal energy from the various components and thereby cools drive assembly 10. More specifically, continuing to refer to FIG. 14, coolant enters one end of conduit 488 within axle 429 by passing through bore 420 in device frame 416 into conduit 488. As coolant passes through conduit 488 is absorbs thermal energy from axle 429 and components such as central body 444, poles 448, and coils 450. Coolant then exits conduit 488 into coolant distribution chamber 462 where it is redirected to flow in a direction (indicated by arrows 474) opposite to the direction it flowed through conduit 488. Coolant then flows through annular passageway 482 in intermediate rotor cap 460. Blades 472 and 484 serve to facilitate the flow of coolant through intermediate rotor cap 460. Coolant that passes through intermediate rotor cap 460 enters magnet containing section 464 where it flows across and contacts magnets 486, stator teeth 452, central body 444, poles 448, and coils 450. When these components are at a temperature higher than the temperature of the coolant, thermal energy from these components is absorbed by the coolant, thereby cooling the components. Coolant then exits magnet containing section 464 through annular passageway 440. Blades 442 in annular passageway may promote flow of the coolant through annular passageway 440.

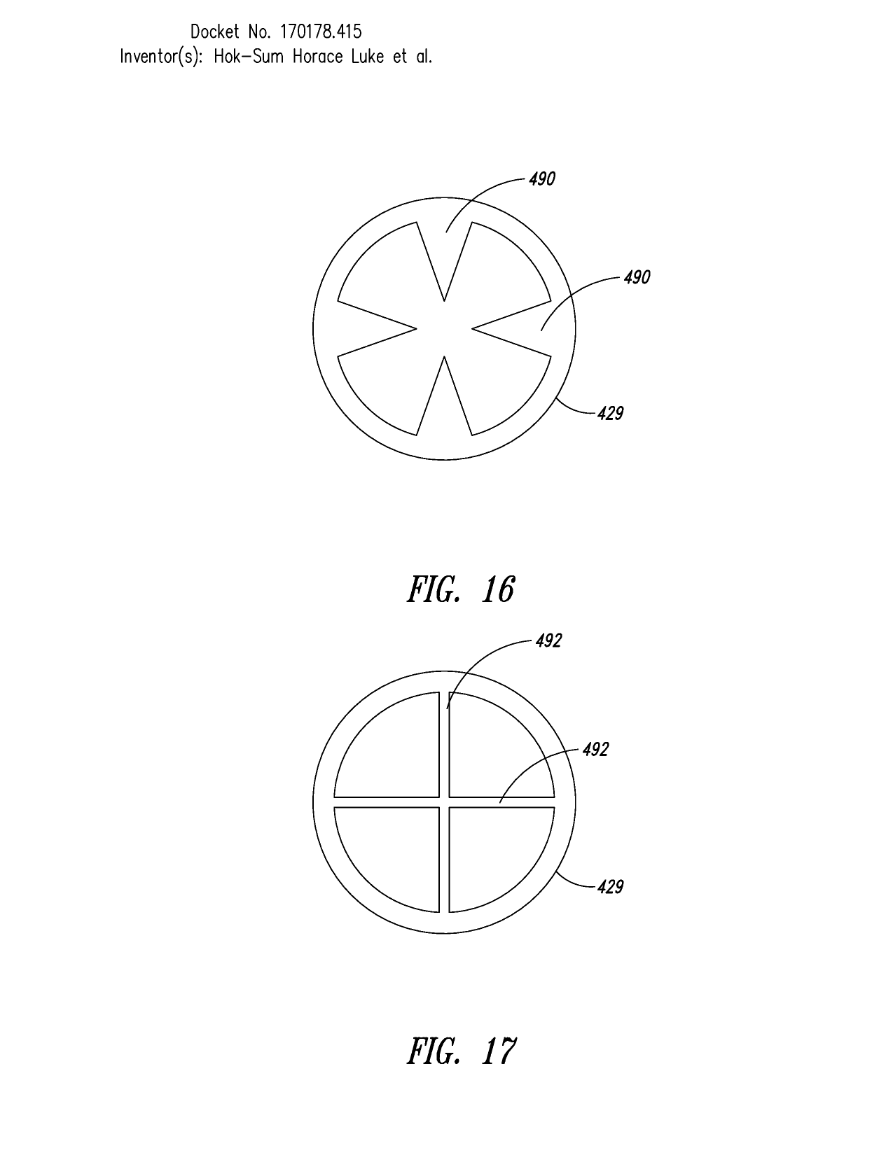

In addition to providing a conduit for cooling, utilizing a hollow axle provides an additional benefit of reduced weight. This reduced weight may come at the expense of a less strong axle, but such reduced strength can be mitigated by provide strengthening members within the coolant conduit as described below with reference to FIGS. 16 and 17.

In the embodiments illustrated in FIGS. 13 and 14, electric current is delivered to coils 450 by wires (not shown) which generates magnetic fields in poles 448 that interact with rotor magnets 486 resulting in a force which causes rotor housing 454 to rotate along with drive mechanism 478. Conductive wires connected to coils 450 can be routed within the conduit 488 and pass through axle 429 through bores in the axle wall (not shown). Alternatively, the conductive wires can be carried on the outer surface of axle 429. The supply of electric current to different coils can be controlled by a motor controller (not shown) receiving inputs from a rotor sensor configured to sense the position of the rotor relative to the coils and provide signals of rotor position to the motor controller.

In certain embodiments, an external fan (not shown) or pump (not shown) is employed to provide a driving force to push coolant through frame 416 into coolant conduit 488. Alternatively, a pump can be fluidly connected to annular passageway 440 in front cover 438 and provide a vacuum to draw coolant through drive assembly 10.

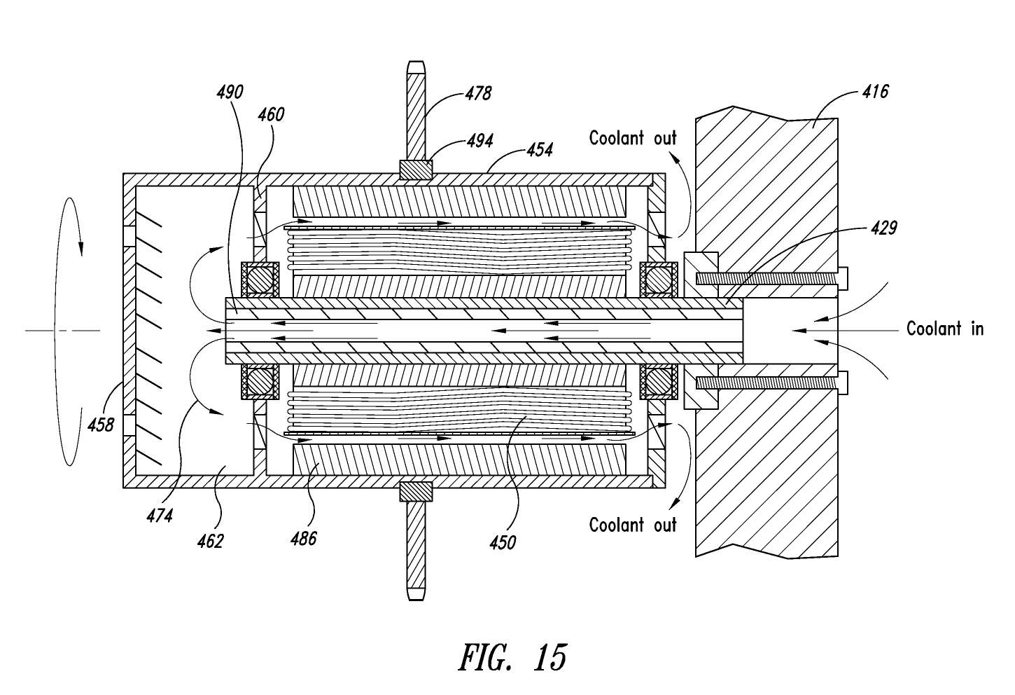

Referring additionally to FIGS. 15, 16 and 17, coolant conduit 488 may include heat transfer members 490 in FIGS. 15 and 16 or 492 in FIG. 17. Heat transfer members 490 in FIGS. 15 and 16 are heat conducting members that are triangular in a cross section perpendicular to the centerline axis 419 and provide surface area in additional to the inner periphery of conduit 488 through which heat transfer from drive assembly components to the coolant may occur. As illustrated in FIG. 15, heat transfer members 490 extend along the entire length of axle 429; however, it should be understood that heat transfer members 490 and 492 need not extend along the entire length of axle 429 and may extend along only portions of the length of axle 429. It should also be understood that while heat transfer members 490 are illustrated as being uniformly spaced circumferentially around the inner periphery of axle 436, they need not be uniformly spaced, for example, they may be unevenly spaced. In addition, it should be understood that heat transfer members in accordance with the embodiments described herein are not limited to the triangular cross section shown in FIG. 16. Other cross-sectional shapes may be employed, such as squares, rectangles, partial circles, and the like.

An alternative shape of a heat transfer member 492 is illustrated in FIG. 17. Heat transfer members 492 in FIG. 17 include intersecting members having a rectangular cross section. In addition to provided increased surface area for heat transfer, heat transfer members 490 and 492 also add structural rigidity and strength to axle 429.

Referring to FIG. 15, in accordance with other embodiments of the present disclosure, drive mechanism 478 is provided on an outer periphery of rotor housing 454. In embodiments in accordance with FIG. 15, drive mechanism 478 includes a boss 494 to which the drive mechanism 478 is affixed and extends. Boss 494 is fixed within a groove in the outer surface of rotor housing 454. In accordance with embodiments of FIG. 15, drive shaft 476 is omitted.

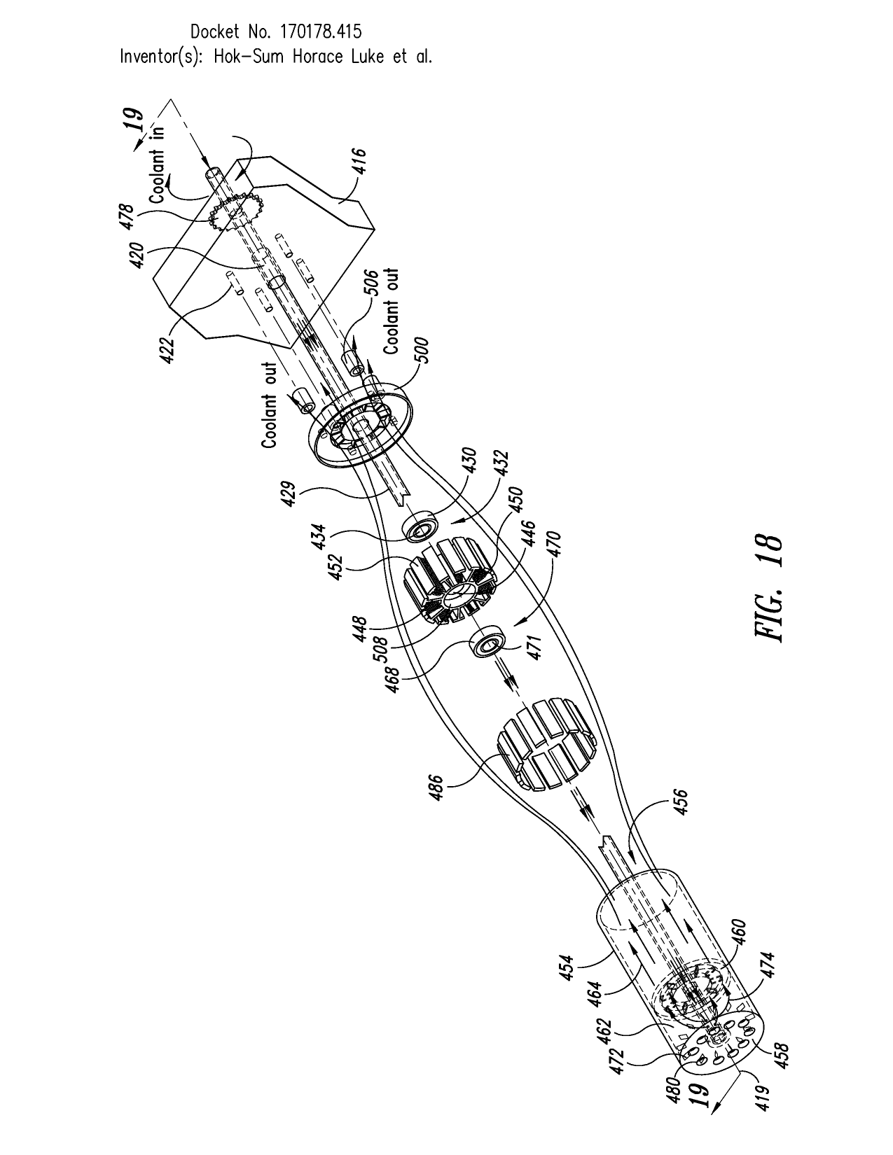

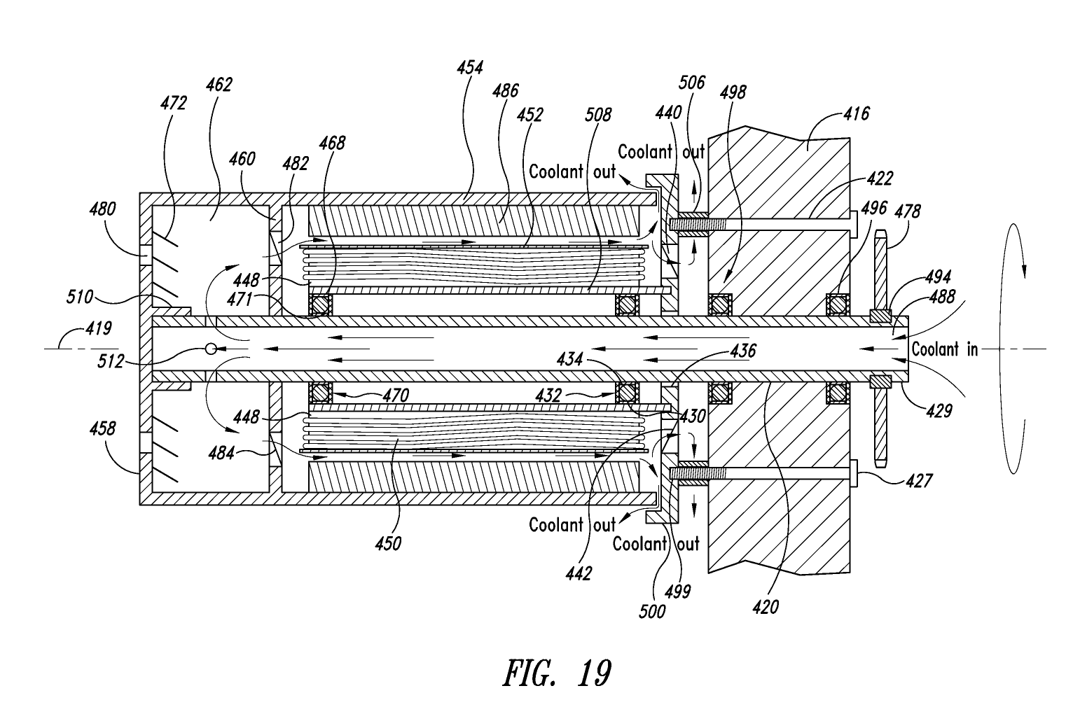

Referring to FIGS. 18 and 19, embodiments of the subject matter described herein relating to an internally cooled drive assembly include embodiments wherein the electric motor is an “outrunner” design. Embodiments in accordance with FIGS. 18 and 19 of the present disclosure differ from embodiments of FIGS. 13-15 in that axle 429 is not secured to device frame 416, but rather is fixed to rotor housing 454 and therefore rotates with rotor housing 454 and relative to device frame 416.

Referring more specifically to FIGS. 18 and 19 wherein features in FIGS. 18 and 19 that are identical or similar to features in FIGS. 13-15 are identified by the same reference numerals. Device frame 416 includes round bore 420 passing through device frame 416. Round bore 420 is provided with optional bearings 496 and 498. The outer race of bearings 496 and 498 are secured to device frame 416 and the inner race of bearings 496 and 498 are secured to the outer surface of axle 429. Cooperation between device frame 416, bearing 496, bearing 498 and axle 429 allow axle 429 to rotate relative to device frame 416. Device frame 416 further includes a plurality of bores 422 sized to pass threaded bolts 427 through device frame 416. The threaded ends of bolts 427 are received in threaded cavities 499 located in a face of front cover 500 facing device frame 416. Front cover 500 is spaced apart from device frame 416 by spacers 506. Front cover 500 resembles front cover 438 in FIG. 13; however, unlike front cover 438 in FIG. 13, front cover 500 is not secured to rotor housing 454. Front cover 500 includes annular passageway 440 that includes optional blades 442. Front cover 500 also includes a central bore 436 sized to permit axle 429 to pass through front cover 500. Though not illustrated, central bore 436 can include bearings (not shown) to further support rotation of axle 429 relative to front cover 500. Extending from the face of front cover 500 opposite device frame 416 is a stator support 508 to which poles 448 are coupled. In the illustrated embodiment, stator support 508 is an annular cylindrical member that is centered on axial centerline 419 and extends parallel thereto. Stator support 508 has an inner diameter greater than the outer diameter of axle 429 and is thus radially spaced from the outer periphery of axle 429. The inner periphery of stator support 508 is coupled to outer race 430 of bearing 432 and outer race 468 of bearing 470. The inner race 434 of bearing 432 and the inner race 471 of bearing 470 are secured to the outer periphery of axle 429. Through this combination of bearings, axle and stator support, axle 429 rotates relative to stationary stator support 508 and supported poles 448. Poles 448 include coils 450 and are capped by stator teeth 452.

Rotor housing 454 includes an open end 456 adjacent, but not connected to, the face of front cover 500 opposite device frame 416. The end of rotor housing 454 opposite open end 456 includes rotor cap 458 that closes the end of rotor housing 454 opposite open end 456. Intermediate open end 456 and rotor cap 458 is an intermediate rotor cap 460 similar to intermediate rotor cap 460 in FIGS. 13 and 14. Intermediate rotor cap 460 in FIG. 19 differs from intermediate rotor cap 460 in FIGS. 13 and 14 in that it is fixed to the outer periphery of axle 429. Intermediate rotor cap 460 in FIGS. 18 and 19 divides rotor housing 454 into coolant distribution chamber 462 and magnet containing section 464 which includes magnets 486.

Intermediate rotor cap 460 includes annular passageway 482 that passes through intermediate rotor cap 460 and provides fluid communication between coolant distribution chamber 462 and magnet containing section 464. Annular passageway 482 may include optional blades 484. The outer periphery of intermediate rotor cap 460 is fixed to the inner periphery of rotor housing 454.

Rotor cap 458 includes vent holes 480 allowing for ingress of coolant into coolant distribution chamber 462 and/or egress of coolant from coolant distribution chamber 462. The inner surface of rotor cap 458 includes optional blades 472. The inner surface of rotor cap 458 also includes coupling member 510 in the form of a round annular sleeve having an inner diameter sized to receive axle 429. Coupling member 510 cooperates with known components to secure axle 429 to coupling member 510.

Continuing to refer to FIGS. 18 and 19, the portion of axle 429 that passes through coolant distribution chamber 462 includes a plurality of holes 512 that allow coolant within coolant conduit 488 in axle 429 to pass from coolant conduit 488 into coolant distribution chamber 462. Coolant in coolant distribution chamber 462 may pass through annular passageway 482 into magnet containing section 464 where it passes across magnets 486, stator teeth 446, poles 448 and coils 450. At the open end 456 of rotor housing 454, the coolant exits the rotor housing through a gap between front cover 500 and rotor housing 454 and/or through annular passageway 440 in front cover 500.

In operation of drive assemblies of the type illustrated in FIGS. 18 and 19, electric current is supplied to conductive coils 450 which generates magnetic fields in poles 448. Such magnetic fields interact with the magnetic fields of magnets 486 which produces force causing rotor housing 454 and axle 429 to rotate relative to the stator assembly 412. Rotation of axle 429 rotates drive mechanism 478 which can be coupled to a system for transferring such rotational movement to other components of the driven device.

The descriptions of other elements of drive assemblies in accordance with embodiments described with reference to FIGS. 13 and 14 are equally applicable to drive assemblies in accordance with embodiments described with reference to FIGS. 18 and 19.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. provisional patent application Ser. No. 61/583,984 entitled “INTERNALLY COOLED DRIVE ASSEMBLY FOR ELECTRIC POWERED DEVICE” and filed Jan. 6, 2012, (Attorney Docket No. 170178.410P1); U.S. provisional patent application Ser. No. 61/546,411 entitled “DRIVE ASSEMBLY FOR ELECTRIC POWERED DEVICE” and filed Oct. 12, 2011 (Attorney Docket No. 170178.411P1); U.S. provisional patent application Ser. No. 61/615,123 entitled “DRIVE ASSEMBLY FOR ELECTRIC POWERED DEVICE” and filed Mar. 23, 2012 (Attorney Docket No. 170178.413P1); U.S. provisional patent application Ser. No. 61/583,456 entitled “ELECTRIC DEVICES” and filed Jan. 5, 2012 (Attorney Docket No. 170178.414P1); U.S. provisional patent application Ser. No. 61/615,144 entitled “ELECTRIC DEVICE DRIVE ASSEMBLY AND COOLING SYSTEM” and filed Mar. 23, 2012 (Attorney Docket No. 170178.415P1); U.S. provisional patent application Ser. No. 61/615,143 entitled “DRIVE ASSEMBLY AND DRIVE ASSEMBLY SENSOR FOR ELECTRIC DEVICE” and filed Mar. 23, 2012 (Attorney Docket No. 170178.416P1), are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A drive assembly for an electric device, the drive assembly comprising:
a static axle, static axle including an internal bore extending along a longitudinal axis of the axle;
a stator assembly fixed to the static axle, the stator assembly having a pole and a coil around the pole; and
a rotor assembly having a housing and a plurality of magnets coupled to the housing;
wherein the stator assembly is positioned within the rotor assembly, and
the housing includes a drive mechanism.

2. The drive assembly of claim 1, the static axle further including an inner surface defining the bore and an outer surface opposite the inner surface, wherein the outer surface includes at least one longitudinal channel extending substantially parallel to a longitudinal axis of the static axle.

3. The drive assembly of claim 2, wherein the stator assembly includes a central bore configured to receive the static axle, the central bore including at least one rib configured to be received in the at least one longitudinal channel of the static axle.

4. The drive assembly of claim 1, the static axle further including an inner surface defining the bore and an outer surface opposite the inner surface, wherein the inner surface includes at least one longitudinal rib extending substantially parallel to a longitudinal axis of the static axle.

5. The drive assembly of claim 1, wherein the static axle further includes a first end and a second end opposite the first end and the longitudinal bore extends from the first end of the static axle to the second end of the static axle.

6. An electric device including a drive assembly comprising:
a static axle, the static axle including an internal bore extending along a longitudinal axis of the axle;
a stator assembly fixed to the static axle, the stator assembly having a pole and a coil around the pole; and
a rotor assembly having a housing and a plurality of magnets coupled to the housing,
wherein the stator assembly is positioned within the rotor assembly, and
the housing is coupled to a drive mechanism.

7. The electric device of claim 6, the static axle further including an inner surface defining the bore and an outer surface opposite the inner surface, wherein the outer surface includes at least one longitudinal channel extending substantially parallel to a longitudinal axis of the static axle.

8. The electric device of claim 7, wherein the stator assembly includes a central bore configured to receive the static axle, the central bore including at least one rib configured to be received in the at least one longitudinal channel of the static axle.

9. The electric device of claim 6, the static axle including an inner surface defining the bore and an outer surface opposite the inner surface, wherein the inner surface includes at least one longitudinal extending rib.

10. The electric device of claim 6, wherein the static axle further includes a first end and a second end opposite the first end and the bore extends from the first end of the static axle to the second end of the static axle.

11. A drive assembly for an electric device, the drive assembly comprising:
a static axle including an internal longitudinal bore, the static axle having an inner surface defining the bore and an outer surface opposite the inner surface, the inner surface further including at least one longitudinal rib extending substantially parallel to a longitudinal axis of the static axle.

12. The drive assembly of claim 11, wherein the static axle includes a first end and a second end opposite the first end and the longitudinal bore extends from the first end to the second end.

13. The drive assembly of claim 11, wherein the longitudinal rib extends from the first end to the second end.

14. A drive assembly for an electric device, the drive assembly comprising:
a static axle including an internal longitudinal bore, the static axle having an inner surface defining the bore and an outer surface opposite the inner surface, the outer surface including at least one longitudinal channel extending substantially parallel to a longitudinal axis of the static axle.

15. The drive assembly of claim 14, wherein the static axle includes a first end and a second end opposite the first end and the longitudinal channel extends from the first end to the second end.

16. A drive assembly for an electric device, the drive assembly comprising:
a static axle including an internal bore containing a first flow path for a coolant fluid and a second flow path for the coolant fluid;
a stator assembly fixed to the static axle, the stator assembly having a pole and a coil around the pole; and
a rotor assembly having a housing and a plurality of magnets coupled to the housing;
wherein the stator assembly is positioned within the rotor assembly, and
the housing includes a drive mechanism.

17. The drive assembly of claim 16, wherein the first flow path is configured to be in communication with a source of coolant fluid.

18. The drive assembly of claim 16, wherein the second flow path is configured to be in fluid communication with a receptacle of coolant fluid.

19. The drive assembly of claim 16, wherein the static axle includes a first end and a second end opposite the first end and the first flow path includes a coolant inlet near the first end and is in fluid communication with the second flow path near the second end.

20. The drive assembly of claim 16, wherein the static axle further comprises a coolant manifold in fluid communication with the internal bore near the first end of the static axle.

21. The drive assembly of claim 16, wherein the internal bore includes a coolant fluid return surface near the second end of the static axle.

22. A method for cooling a stator assembly fixed to a static axle that includes a first end and a second end opposite the first end, the method comprising:
near the first end, receiving coolant fluid into an internal bore within the static axle;
flowing the coolant fluid toward the second end;
near the second end, changing the direction of flow of the coolant fluid;
transferring thermal energy to the coolant fluid; and
removing the coolant fluid from the internal bore near the first end.

23. The method of claim 22, wherein receiving coolant fluid into the internal bore further comprises receiving the coolant fluid into a first flow path provided within the internal bore and flowing the coolant fluid toward the second end further comprises flowing the fluid coolant in the first flow path toward the second end.

24. The method of claim 23, wherein changing direction of flow of the coolant fluid further comprises near the second end, flowing the coolant fluid out of the first flow path and into a coolant return surface that directs the coolant fluid into a second flow path extending from near the second end to near the first end.

25. The method of claim 24, further comprising flowing the coolant fluid towards the first end.
